(19) United States
(12) Patent Application Publication
(10) Pub. No.: US 2024/0021852 A1
(43) Pub. Date: Jan. 18, 2024

(54) SYSTEM, METHOD AND APPARATUS FOR HYDROGEN MANAGEMENT

(71) Applicant: H2 Clipper, Inc., Santa Barbara, CA (US)

(72) Inventors: Rinaldo S. Brutoco, Santa Barbara, CA (US); Robert H. Shelton, Santa Barbara, CA (US); Matthew Knapp, Redmond, WA (US); Bob Boyd, Spring Lake, NJ (US)

(73) Assignee: H2 Clipper, Inc., Santa Barbara, CA (US)

(21) Appl. No.: 18/057,527

(22) Filed: Nov. 21, 2022

Related U.S. Application Data
(60) Provisional application No. 63/388,686, filed on Jul. 13, 2022.

(51) Int. Cl. H01M 8/04082; H01M 8/04014; H01M 8/04111; H01M 8/04746; H01M 8/0432; H01M 8/0438; F17C 7/04

(52) U.S. Cl. CPC H01M 8/04208; H01M 8/04014; H01M 8/04111; H01M 8/04753; H01M 8/04328; H01M 8/04388; F17C 7/04; H01M 2200/20; H01M 2250/20; F17C 2221/012; F17C 2205/0352; F17C 2227/0323; F17C 2270/0184; F17C 2227/0135; F17C 2227/0157; F17C 2205/0326; F17C 2205/0332; F17C 2270/0189; F17C 2270/0171; F17C 2270/0105; F17C 2203/0619; F17C 2250/043; F17C 2250/0439; F17C 2250/0417; F17C 2250/0443; F17C 2250/03; F17C 2265/06

(57) ABSTRACT

A system, method and apparatus are disclosed for enabling the efficient utilization of hydrogen as an emissions-free fuel for airships and other aircraft, including in one embodiment for transporting cryogenic hydrogen as the airship's payload. A system, method and apparatus are disclosed to provide substantially higher net energy density for the propulsion system, optimizing the weight of the cryogenic tanks, utilizing boiloff directly or indirectly for propulsion power, and employing a novel thermal management system both to cool the fuel cells and help regulate the conversion of liquid hydrogen into gas. A system, method and apparatus are also disclosed for ground-based facilities including strategically located depots, optionally supplied by such hydrogen transport vehicles, and utilizing a novel thermal compression system to store, pressurize and distribute hydrogen, including but not limited to gaseous hydrogen pipelines, transport trailers, and dispensing systems.

### CROSS-REFERENCE TO RELATED APPLICATION

This application claims the benefit of priority under 35 U.S.C. § 119(e) to U.S. Provisional Application No. 63/388,686, filed on Jul. 13, 2022, entitled, “SYSTEM, METHOD AND APPARATUS FOR HYDROGEN MANAGEMENT”. The entire contents of this patent application are hereby incorporated by reference herein.

### FIELD OF THE INVENTION

The subject technology generally relates to the use of hydrogen as a primary fuel for a fuel cell electric propulsion system or other hydrogen fueled propulsion system in aviation vehicles. While the subject technology may be used in a variety of aircraft applications, ships and certain ground-based installations, it is particularly useful in airships and is especially beneficial in airships that are used to transport hydrogen to market from locations where hydrogen can be produced most advantageously to areas where clean energy is most needed.

The subject technology provides a method for overcoming the traditional challenges of requiring exceedingly heavy tanks to store hydrogen in gaseous or liquified form, as well as the high weight and drag penalty of needing heavy thermal management systems to dissipate the heat generated by fuel cells. Through such weight savings and other attributes of the invention disclosed herein, the subject technology thereby provides a more energy-efficient and in turn, a more cost-effective means of transitioning to hydrogen as a zero-carbon alternative fuel for use in aviation applications and other mobility and stationary applications.

The subject technology also relates to the storage of hydrogen at scale in ground-based facilities involving storage and distribution of cryogenic and gaseous hydrogen. While the subject technology may be used in a variety of applications, it is particularly beneficial in strategically located depots that receive bulk quantities of liquid hydrogen from airships designed to transport cryogenic hydrogen from remote production locations. Such depots may be configured for a single user or for serving multiple end-users requiring liquid and/or gaseous hydrogen through pipelines, tube trailer trucks and/or hydrogen dispensing stations at predetermined pressure levels.

### BACKGROUND OF THE INVENTION

The use of hydrogen fuel cell electric propulsion in aviation has long been viewed as being desirable as a way to decarbonize air transport since such a system's only byproduct is pure water vapor. However, the low density of hydrogen gas makes this goal very challenging because the space required to store adequate amounts of hydrogen gas far exceeds the available space unless the hydrogen is stored at high pressure or cooled to −252.9° C., at which point the gas converts into a liquid. Both of these approaches require very heavy tanks, either to contain the high pressure, or as a double wall vacuum construction or single-wall tank with insulation to minimize the rate of boil-off. The weight of such tanks significantly reduces the commercial and technical feasibility of using hydrogen in aviation mobility applications based on current technology. As a result of these and other challenges, most aircraft designers estimate that it will require several generations of improvements in current fuel cell technology, storage tank design, and other associated systems for hydrogen to become commercially viable as an aviation fuel.

As an alternative to the high-pressure gaseous hydrogen tanks and double wall vacuum tanks, liquid hydrogen can also be stored in lightweight, single-wall storage tanks with minimal insulation as has been done for decades in rockets. The single wall tank will lose liquid hydrogen due to off-gassing far more rapidly than a double wall vacuum insulated tank, but for rocket applications where the tanks are filled shortly before launch, off-gas venting is tolerated to keep the rocket weight as low as possible. Unlike rockets, where the fuel is consumed very rapidly following launch, traditional aviation applications require carrying the fuel for several hours or even days. Accordingly, under these conditions, such tanks have not been useful for conventional aircraft or airships.

A measure of efficiency for a storage tank is how much of the total filled tank weight is actually the weight of the contained fluid or gas. The weight factor can be expressed by the “mass fraction” of the storage system, which is the weight of the hydrogen content divided by the total weight of the filled tank. Using current technology, high pressure tanks presently have a mass fraction of 5-8%, while cryogenic tanks have a mass fraction of 15-20%. Since between 80% and 95% of the total weight of the system is the tank rather than the fuel it contains, in either case, the resulting energy density of the system, as measured in kWh/kg, is extremely low.

Utilization of hydrogen storage tanks with such low mass fractions may be acceptable for use in stationary applications and in cars, trucks, buses, trains, and other ground-based vehicles, but is challenging for aviation applications where minimizing weight is absolutely critical. Thus, although hydrogen has three times the energy density of conventional jet fuel, the combined weight of hydrogen plus the weight of the containment tanks results in a net energy density that is far lower than jet fuel, thereby generally making hydrogen ill-suited as an aviation fuel. However, the 3-times advantage of hydrogen over Jet-A in energy density means that a path to viable applications in aviation may be possible with lightweight tanks since a mass fraction of 33% would put the energy density of the stored system on parity with Jet-A, and even higher mass fractions would provide an advantage over conventional fuels.

It is well known that hydrogen fuel cells are thermodynamically more efficient and environmentally preferable for the production of power than burning the hydrogen in a gas turbine, which has the additional disadvantage of producing NOx emissions as a byproduct of combustion. However, it is broadly accepted that using current technology, a fuel cell electric power generation system combined with an electric motor propulsion system is substantially heavier than the equivalent gas turbine due to the additional weight of the systems needed for thermal management and fuel storage. Accordingly, using current technology, these concerns have led the aviation industry to generally forego the known advantages of a fuel cell electric system and look for other alternatives except in the area of very lightweight aircraft or planes anticipated to serve relatively short routes. What has been missing is a way to reduce the overall weight of the hydrogen tanks and the thermal management system, which are the principal objectives of the disclosed system, method and apparatus.

Generally speaking, the challenges of thermal management with fuel cells are twofold. First, fuel cells produce a considerable amount of waste heat per energy output (e.g., a 50% net thermodynamically efficient fuel cell produces equal amounts of heat and electrical power) that must be actively removed; and second, this heat is “low grade” (with a temperature that is typically less than 100° C.) and is therefore requires far larger heat exchangers than an equivalent high temperature source. This combination of factors requires a system of pumps, coolant, and large heat exchangers with correspondingly great weight and drag penalties.

In this disclosure, a novel system, method, and apparatus are proposed to overcome the challenges of low mass fraction hydrogen storage, as well as the weight and drag penalties of fuel cell thermal management systems, thereby dramatically improving the technical and economic attractiveness of hydrogen use in aircraft. Additional benefits are then disclosed when the system is utilized in airships, which are able to further utilize hydrogen as a lifting gas and to employ water byproduct from the fuel cells for buoyancy compensation. For purposes of illustration and not limitation, this disclosure will be made with respect to use in an airship to transport hydrogen to market and to transport freight on the airship's return to the point of origin, as well as the ground-based operations associated therewith.

This disclosure also incorporates a novel system, method, and apparatus of depots where such airships may deposit bulk quantities of liquid hydrogen. Such depots contain storage, distribution and energy-generation systems to recover a substantial amount of the energy used to liquify the hydrogen at or near the location where it is produced, as well as to manage the boil-off of liquid hydrogen. The disclosed system, method and apparatus for such depots includes, among other novel attributes, a means of thermal compression that can be used in lieu of traditional mechanical compression systems to provide the appropriate levels of compressed hydrogen gas for storage and local distribution by pipeline, truck and hydrogen dispensing systems.

### SUMMARY OF THE INVENTION

In one aspect of the present disclosure, the subject technology relates to using a system of cryogenic and non-cryogenic tanks, heat exchangers, and fuel cells to generate power including propulsion power for aircraft, and in particular airships.

In a further aspect of the present disclosure, the subject technology relates to the design and implementation of a hydrogen fuel-cell electric propulsion system for aircraft including airships.

In some illustrative embodiments, a set of one or more tanks store sufficient liquid hydrogen in a cryogenic state to provide the required fuel to transport cargo or other payload for a desired time or distance.

In other embodiments, a plurality of tanks is used to transport liquid hydrogen in a cryogenic state, those tanks being used first, during flight, to provide fuel for propulsion, and second, the remaining cryogenic hydrogen being delivered as payload at the destination.

In one illustrative embodiment, the plurality of storage tanks is of single-wall construction and are connected by means of piping to a single “header” or “feeder” tank which may be of single or double wall vacuum construction. The feeder tank is then connected by means of valves and piping and one or more heat exchangers to a gaseous hydrogen reservoir which functions as the primary fuel source for the propulsion system.

In a further illustrative embodiment, the propulsion system consists of a plurality of fuel cells powering one or more electric drive motors and which may also provide all additional electrical power required for the aircraft or airship systems.

In another illustrative embodiment, the excess heat released by such one or more fuel cells in producing power is then rejected by means of a coolant loop in a virtuous cycle of warming the cryogenic hydrogen to the appropriate temperature for use as gaseous hydrogen fuel while simultaneously pressurizing the gaseous hydrogen to an appropriate level for supplying the fuel cell electric power system and cooling such hydrogen fuel cell(s).

In a further illustrative embodiment, in order to avoid losses due to venting, the propulsion system of the aircraft is sized to require at least as much hydrogen for fuel as the gaseous hydrogen that is generated by the boiloff as the cryogenic hydrogen warms.

While an airship is neutrally buoyant and can fly at any speed or no speed at all, in one illustrative embodiment the airship propulsion system is sized to operate at speeds that are sufficient to utilize all of the hydrogen boiloff for propulsion fuel.

In another illustrative embodiment, the use of single-wall tanks will minimize overall system weight and operation of the airship at a cruising speed of about 150 miles per hour will consume the estimated boiloff of approximately 10-20% of such single-wall tanks' volume per day.

In one embodiment, the system will have both a gaseous hydrogen and a liquid hydrogen pathway from the liquid hydrogen storage tanks to the gaseous hydrogen reservoir.

In a further illustrative embodiment, these will be separate pathways, each with a means of pressurization such as a turbopump, compressor and/or thermal compression system, and each with a heat exchanger, the combination of which is sufficient to raise the temperature of the hydrogen flowing through such pathway to near ambient levels and the pressure to the level required in the gaseous hydrogen reservoir serving as a source of hydrogen fuel.

In another embodiment, the boiloff gas may be entrained with the liquid hydrogen flow pathway, and from there to pass through a common heat exchanger.

In one illustrative embodiment, such entrainment may occur in the turbopump for the fluid.

In an alternative embodiment, such entrainment may occur in the piping between the liquid hydrogen tank and the heat exchanger.

During normal operations, the gaseous hydrogen needed by the fuel cells is provided partially from the liquid hydrogen and partially from gaseous hydrogen boiloff, and a control system is used to continuously adjust the amount of liquid hydrogen such that the boiloff gas is preferentially utilized.

In one illustrative embodiment, the control system receives information about the current state of the system including temperatures, pressures, and flow rates from a comprehensive network of sensors, and adjusts such flow rates, temperatures, and pressures by utilizing system hardware, including valve positions and pump flow rates.

In a further illustrative embodiment, the control system determines the amount of hydrogen boiloff in all LH2 storage tanks and then maintains a set pressure in the liquid hydrogen storage tanks by fully utilizing the boiloff gas with adjustments as needed to compensate for pressure variations. Having determined boiloff gas flow rate, the control system then ensures that additional hydrogen needed to meet propulsion demand is provided from the liquid hydrogen source.

In one illustrative embodiment, the control system utilizes heuristics that account for the lag time between initiating changes to physical components such as opening or shutting a valve, and the effect of such changes on actual temperature and pressure levels.

In a further illustrative embodiment, a feedback loop is provided through which such control system heuristics are refined, and the control inputs are thereby adjusted for actual operating conditions, as these change from time to time during flight.

In another illustrative embodiment, to ensure the gaseous hydrogen reservoir that supplies hydrogen to the fuel cells is maintained within the correct bounds for operating pressure and temperature, the control system uses one or more turbopumps and commands pump flow rate to regulate pressure, while regulating temperature by setting the flow rate of high temperature fluid in the heat exchanger through use of one or more cooling system pumps and valves.

In a further illustrative embodiment, heat is applied to one or more liquid hydrogen tanks to promote boiloff and thereby raise the gaseous hydrogen pressure.

In yet another illustrative embodiment, the amount of heat applied to such one or more hydrogen tanks to promote boiloff is sufficient to eliminate the need for any mechanical means of pressurizing such gaseous hydrogen.

In another embodiment, the control system adjusts the flow of heat to one or more liquid hydrogen tanks to reach and maintain the pressure needed to feed gaseous hydrogen from the heat exchanger to the gaseous hydrogen reservoir; and in such embodiment, the control system optionally sets the flow rate of high temperature fluid in the heat exchanger by adjusting one or more cooling system pumps and valves to regulate temperature.

### BRIEF DESCRIPTION OF THE DRAWINGS

FIG. 1 shows an overview schematic of liquid and gaseous hydrogen pathways from cryogenic liquid storage to the ambient, gaseous high-pressure reservoir for utilization;

FIG. 2, including sub-parts 2(a) and 2(b), shows in FIG. 2(a) a schematic of the hydrogen storage and thermal management components from initial fill lines to the gaseous hydrogen reservoir that supplies hydrogen to one or more fuel cells. FIG. 2(b) shows a schematic for an alternative configuration of such components and the heat exchange unit(s) comprising such thermal management apparatus;

FIG. 3 shows a more detailed schematic of the associated piping and systems required for safe and effective operation of the hydrogen storage tanks;

FIG. 4 shows a system for purging the one or more cryogenic storage tanks with near-cryogenic gaseous hydrogen when emptying the storage tanks, and for managing the water produced by the one or more fuel cells;

FIG. 5 shows an overview schematic of the propulsion system in a preferred embodiment including representation of the fuel, thermal and propulsion systems;

FIG. 6 is a table identifying operating states of the system during normal operation;

FIG. 7 is a table of instrumentation required for safe and effective control of liquid and gaseous hydrogen flow through the system;

FIG. 8 presents the steps required to determine the current operating state of the system;

FIG. 9 is a block flow diagram illustrating the interconnection of the hydrogen transport vehicle with ground-based operations associated therewith;

FIG. 10 is a schematic diagram depicting the production and loading of liquid hydrogen onto the hydrogen transport vehicle at the point of origin, corresponding to a location where hydrogen is produced for export;

FIG. 11 is a schematic diagram depicting the unloading of liquid hydrogen from the hydrogen transport vehicle at the destination, corresponding to a location where hydrogen is imported; as well as the storage and preparation of such hydrogen for distribution for addressing end-use applications; and

FIG. 12 is a schematic diagram depicting the optional use of thermal compression at depots and other hydrogen import locations to build the pressure desired for GH2 storage, transport, and distribution.

While implementations are described herein by way of example, those skilled in the art will recognize that the implementations are not limited to the examples or drawings described. The drawings and detailed description thereto are not intended to limit implementations to the form disclosed but, on the contrary, the intention is to cover all modifications, equivalents and alternatives falling within the spirit and scope as defined by the appended claims. As used throughout this application, the word “may” is used in a permissive sense (i.e., meaning having the potential to) rather than the mandatory sense (i.e., meaning must). Similarly, the words “include,” “including,” and “includes” mean including, but not limited to.

As used herein, the terms “coupled” or “attached” may refer to two or more components connected together, whether that connection is permanent (e.g., welded, brazed or glued) or temporary (e.g., bolted, held by a pin, held in place by friction or tension, or through pairing), direct or indirect (i.e., through an intermediary), mechanical, chemical, optical or electrical. Also as used herein, the terms “algorithm” or “algorithms” are intended to represent one or more instructions and/or procedures that may be implemented by any of human actions taken, computer-based operations performed, and/or the application of artificial intelligence and machine learning that are programmed, configured or trained for the express purpose of transforming one or more facts, data and information concerning the system or component thereof, the context, and/or environment in which it exists into actions such as initiating, monitoring, controlling, regulating, calibrating, activating and deactivating various processes, as well as coupling and decoupling, partially or completely opening and closing various valves, lines and circuits, and the like. Additionally, the term “working fluid” as used herein refers to the use of a liquid or gas in a refrigeration, heating, or cooling cycle or control system actuation such as valves and pressurization systems; and the terms “off-gassing” and “boil-off” are used interchangeably to refer to the release of hydrogen, and the hydrogen gas thereby produced, as the temperature of liquid hydrogen rises above cryogenic levels.

### DETAILED DESCRIPTION OF THE DRAWINGS

In the following detailed description, numerous specific details are set forth in order to provide a thorough understanding of the aspects and implementations of the present disclosure. It will be understood by those of ordinary skill in the art that these may be practiced without some of the specific details that are set forth. Moreover, in some instances, well known methods, procedures, components, and structures may not have been described in detail so as not to obscure the details of the implementations of the present disclosure.

It is to be understood that the details of construction in the arrangement of the components set forth in the following description or illustrated in the drawings are not limiting. There are other ways in which the principles disclosed may be practiced, controlled, or carried out. Also, it is to be understood that the phraseology and terminology employed herein are for the purposes of description only and also should not be regarded as limiting.

Further, certain features, which are described in the context of separate implementations, may also be provided in combination in a single implementation. Conversely, various features, which are, for brevity, described in the context of a single implementation may also be provided separately or in any suitable sub-combination.

In one aspect of the present disclosure, the subject technology provides improvements over the prior art, including a new and unique system, method, and apparatus for storing hydrogen that overcomes the well-recognized challenges of needing to use exceedingly heavy tanks to store hydrogen in gaseous or liquified form. The subject technology also includes a new and unique system, method, and apparatus for providing thermal management to dissipate heat generated by fuel cells and for reducing or entirely avoiding the need for mechanical systems to pressurize gaseous hydrogen when and as needed to achieve adequate flow rates, to provide the appropriate inlet pressure for injection into such fuel cells, and for hydrogen delivery, storage and dispensing systems.

Through such improvements over the current state of art in hydrogen storage, thermal management and compression approaches, the subject technology overcomes the weight and drag penalty associated with the use of hydrogen as a primary fuel for aviation vehicles. Although described with respect to a fuel cell electric propulsion system, the subject technology may also be employed in conjunction with combustion engines and/or turbine propulsion systems in accordance with the principles of the invention. Through such weight savings and other attributes disclosed herein, the subject technology thereby provides a more energy-efficient and in turn, more-cost effective means of transitioning to hydrogen as a zero-carbon alternative fuel for use in aviation applications.

In comparison to a conventional system of liquid petroleum fuel tank(s) and combustion engine(s), the management of cryogenic hydrogen and conversion to power is substantially more complicated and requires a number of innovative steps, systems and processes to produce a sufficiently high-power system that is not prohibitively heavy for flight. These innovative steps, systems and processes include the use of reduced insulation, cryogenic hydrogen tanks in which boiloff is utilized in part or in whole for fuel, and also in which the energy to warm the cryogenic hydrogen to ambient temperature is provided by waste heat from the fuel cells, thus reducing the requirement and associated expense of heavy heat exchangers that increase drag.

In another aspect of the present disclosure, the subject technology provides improvements over the prior art, including a new and unique system, method and apparatus for the ground-based operations associated with such hydrogen transport vehicle. Such system, method and apparatus include improvements in interconnecting the transport vehicle with such ground-based facilities and assuring that neutral buoyancy is maintained during the steps of loading and unloading liquid hydrogen, water and/or cargo. The subject technology also includes a new and unique system, method and apparatus for providing thermal management to produce electrical power as a byproduct of transforming the hydrogen from liquid to gaseous form, and for reducing or entirely avoiding the need for mechanical systems to pressurize such gaseous hydrogen when and as needed to achieve adequate flow rates and to provide the appropriate inlet pressure for injection into systems used to store, distribute, and dispense the hydrogen to end users.

These and other aspects of the subject technology are disclosed through use of the following illustrative figures.

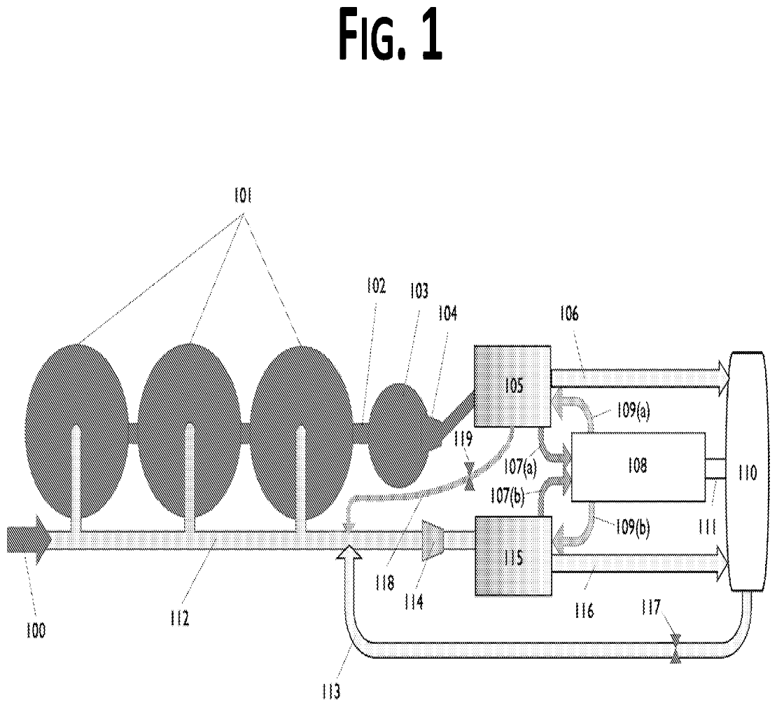

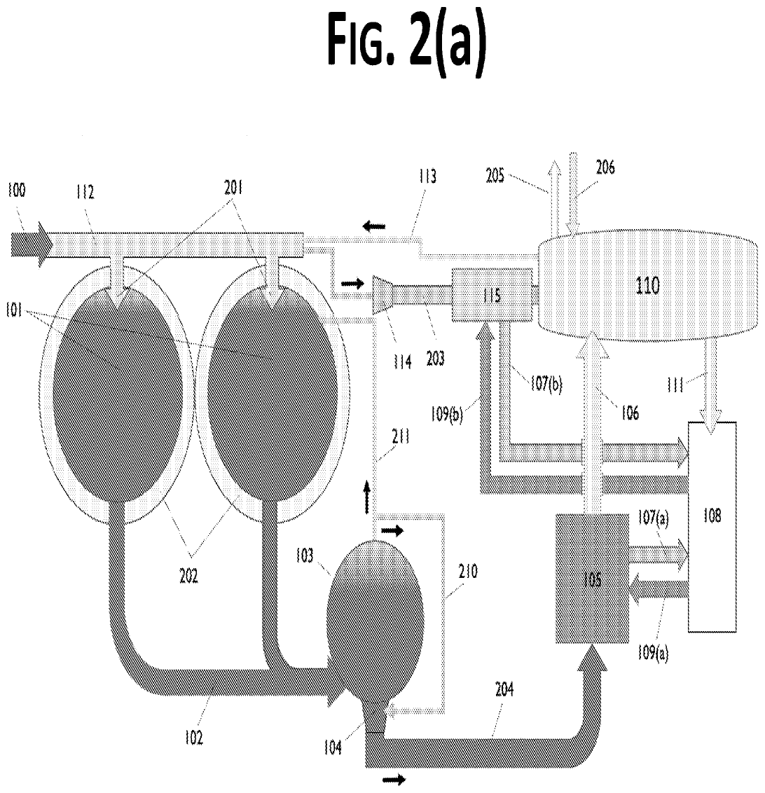

FIG. 1 provides a top view of the liquid and gaseous hydrogen management system, showing a schematic representation of all major components (not drawn to scale) of the system and apparatus and their inter-connections. The schematic shows a plurality of liquid hydrogen (LH2) storage tanks 101 on the left side; a gaseous hydrogen (GH2) storage tank 110 on the right side; and a set of piping pathways and heat exchangers connecting these tanks. Specific valves are not shown at this overview level. In a typical implementation, two of these systems would be employed on the airship, one on the left side and the other on the right side of the craft. In a preferred embodiment, the number of LH2 tanks 101 in each of these systems could be as few as a single tank in each system, and as many as 12 or more tanks, with the actual number of LH2 storage tanks being based on the anticipated service requirements of the airship.

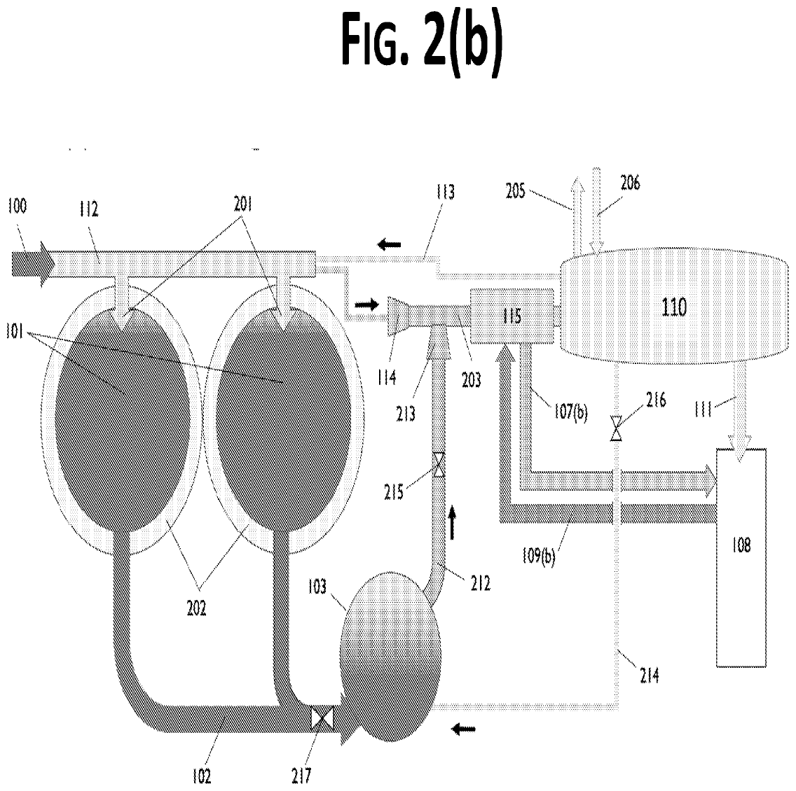

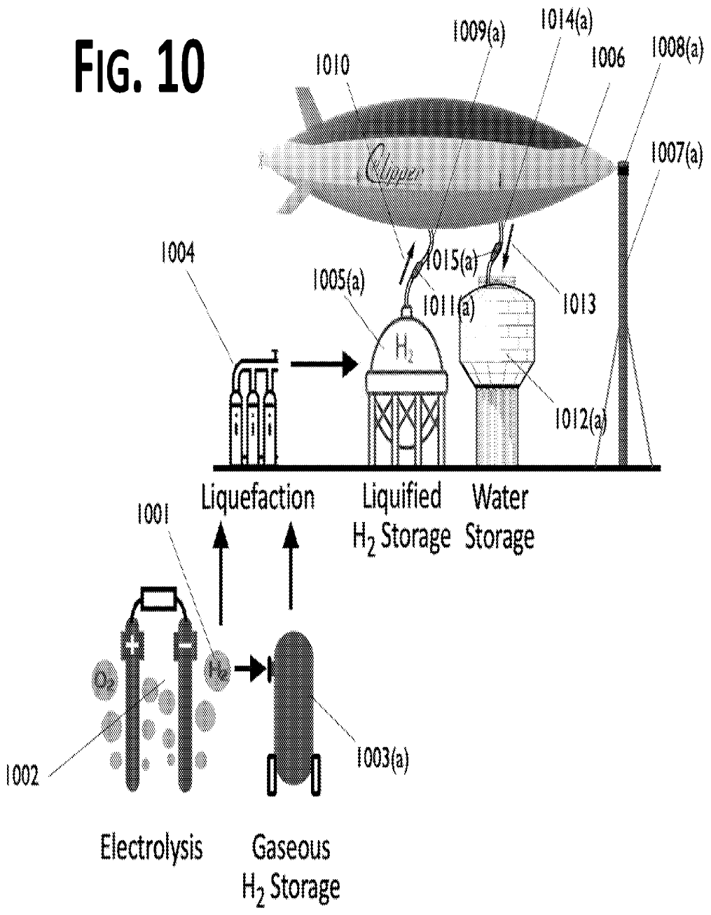

Each of LH2 tanks 101 is connected at the top of the tank by a set of piping and manifolds 112 that may be used to fill the tanks via connection to an external source of LH2 such as one or more Liquified H2 Storage tanks 113(a) illustrated in FIG. 1(a) of Applicant's previously issued U.S. Pat. No. 11,236,864, which is incorporated herein by this reference (the '864 patent), corresponding to liquified H2 storage tank 1005 in FIG. 10 hereof. Persons of ordinary skill in the art will understand that the connection of manifold 112 to such one or more external storage tanks may utilize various pipes, hoses and couplings, the introduction of such LH2 through such coupling being represented by arrow 100 and more particularly described with respect to FIG. 10. Once filled, manifold and connections 112 are used for off-gassing regulation and pressure management, both of which functions are described in greater detail with respect to FIG. 2. In addition, LH2 storage tanks 101 are connected at the bottom by a set of piping and manifolds 102 which, in an alternative embodiment, may be used to fill the tank with liquid hydrogen in addition to providing liquid hydrogen to the propulsion system. In a preferred embodiment, piping and manifolds 102 and 112 are insulted to minimize heat transfer and frost buildup, for example by using double wall vacuum pipes.

Further, it will be recognized by persons of ordinary skill in the art that the piping connections to LH2 storage tanks 101 may vary depending on the shape and orientation of such LH2 tanks, and that the implementation shown in detail herein with a spherical tank utilizing an upper gaseous connection and lower liquid connection is only one example. In another example, a cylindrical tank with hemispherical dome ends might have both connections on either one of the ends, and the appropriate internal plumbing such that the vent and liquid lines access the appropriate space in the tank. It will further be recognized that the details of these connections are not of significance to the innovation so long as there are clearly defined and properly implemented piping connections for both the gaseous and liquid portions of the tank.

Starting from LH2 storage tanks 101, there are two primary pathways to GH2 storage tank 110, one pathway for LH2 and the second for GH2. The LH2 pathway begins with drainage pipe 102 located below LH2 storage tanks 101, which allows the one or more LH2 storage tanks 101 to drain into a smaller, header tank 103. Turbopump or compressor 104 pressurizes the LH2 and pushes it through heat exchanger 105 in which waste heat is carried by a working fluid through piping 109(a) from one or more fuel cells 108, and cold fluid is piped back through pipe 107(a) to cool these one or more fuel cells 108. The foregoing described configuration thus provides a virtuous cycle of low grade heat rejection from the fuel cells while simultaneously heating, vaporizing, and pressurizing the LH2 to ambient temperature GH2. GH2 transfer line 106 enables pressurized GH2 to flow from heat exchanger 105 into GH2 reservoir 110 for use in fuel cells 108 via inlet piping manifold 111.

The GH2 pathway is similar. This pathway sources cold boiloff hydrogen gasses from the one or more LH2 storage tanks 101 to avoid excessive pressure build-up in such tanks. Cold GH2 from manifold 112 may be pressurized by turbopump or compressor 114 before entering GH2 heat exchanger 115 which has functionally the same thermal connections as described above to the one or more fuel cells 108 as LH2 heat exchanger 105. Waste heat from fuel cells 108 is carried by a working fluid into GH2 heat exchanger 115 through piping 109(b); and warmed and pressurized GH2 is piped from heat exchanger 115 into GH2 reservoir 110 via GH2 transfer line 116, with the now-cooled working fluid piped back through pipe 107(b) to cool the one or more fuel cells 108. As will be readily understood by persons of ordinary skill in the art, a heat exchanger with such extreme temperatures, in this case ranging from 23 Kelvin to ambient or near-ambient fuel cell inlet temperature, may involve multiple stages with working fluids at different temperatures as the hydrogen undergoes substantial temperature and pressure changes. Accordingly, in this implementation, the use of the term “a heat exchanger” is understood to encompass a system in which one or multiple heat exchangers may be used, each with the required sections and stages to accomplish an intended change in temperature.

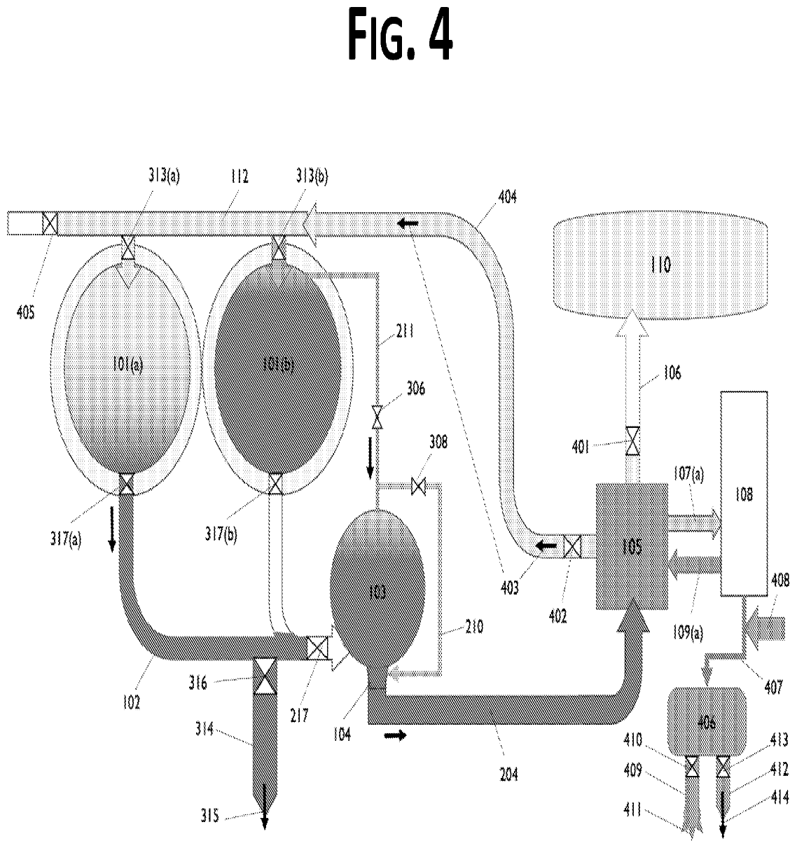

In addition to providing ambient temperature, high pressure GH2 to reservoir 110, FIG. 1 also illustrates two other optional pathways of a preferred embodiment of the system. In some cases, during normal operation, it may be desirable to pressurize storage tanks 101 by utilizing return path 113 from GH2 reservoir 110. In these cases, valve 117 is used to regulate the amount of GH2 flowing back to LH2 storage tanks 101 through manifold 112. In addition, at times when the system operator wishes to empty LH2 storage tanks 101, a source of GH2 may be used to replace the drained LH2 fluid. For operations where it is desirable to use very cold GH2, this can be provided through return line 118 from the LH2 side heat exchanger 105 and this return flow of very cold GH2 is regulated using valve 119. This system and method are further described with respect to FIG. 4, below.

Turning next to FIG. 2(a), a side view is provided showing the components (not drawn to scale) of the liquid and gaseous hydrogen management system of FIG. 1 and illustrating therein additional details regarding the hydrogen storage and thermal management components of the system and apparatus. As described with respect to FIG. 1, the one or more LH2 storage tanks 101 may be filled from an external source of LH2, represented by arrow 100, via piping and manifolds 112 feeding into the top of each LH2 storage tank 101 through its respective spray bar 201, as illustrated by the arrows shown. Although in some cases these tanks may employ double wall vacuum construction, in a preferred embodiment, LH2 storage tanks 101 are preferably fabricated using a single wall construction and coated with one or more layers of insulation as illustrated by insulation material 202 in order to minimize overall system weight. Other means of insulation, including but not limited to the use of aerogel beads as disclosed in U.S. Pat. No. 9,829,155, issued to Alexander Brooks, et. al., and entitled “Cryogenic liquid tank,” may be employed, for insulation material 202.

In one alternative embodiment, such LH2 storage tanks 101 are preferably maintained at or near atmospheric pressure, and in an alternative embodiment, the tanks may be designed to operate at various pressure levels up to approximately 15 bar with several benefits including the ability to minimize off-gassing or to assist in discharging LH2 by pressurizing such LH2 storage tank(s) 101 when off-loading the liquid at a destination. While such higher pressures tend to increase tank weight, in some embodiments, a net weight savings can be realized through reducing the weight of other systems, for example, by enabling a reduction in the size or elimination of turbopumps or compressors 114 and/or 104.

As described with respect to FIG. 1, LH2 storage tanks 101 ultimately provide hydrogen to GH2 reservoir 110 through one of two pathways, one in which off-gassing of GH2 from LH2 storage tanks 101 is removed via manifold 112; and in the other pathway, by draining LH2 to header tank 103 through drainage pipe 102. The priority in utilization of these pathways is first the off-gassing GH2 through manifold 112 to prevent pressure buildup outside of the operating pressure range of the system, and second the liquid hydrogen from drainage pipe 102 as needed to meet any remaining demand for hydrogen as fuel.

The off-gassing pathway from LH2 storage tanks 101 to GH2 reservoir 110 optionally employs turbopump or compressor 114 to pressurize the hydrogen to a higher pressure than GH2 reservoir 110 and thereby to achieve a flow rate that matches the rate of boil-off. After turbopump or compressor 114, pressurized GH2 flows through pipe 203 to heat exchanger 115 to warm the GH2 to a near-ambient temperature. As described with respect to FIG. 1, waste heat carried by means of a working fluid from fuel cells 108 is routed by piping 109(b) through heat exchanger 115 to raise the GH2 temperature while the now cooled working fluid is piped back through pipe 107(b) to cool fuel cells 108 in a virtuous cycle. During periods of low power output, or if there is a large volume of liquid hydrogen being transported as cargo, the off-gassing from LH2 storage tanks 101 through this pathway may be sufficient alone to maintain the needed flow of hydrogen to GH2 reservoir 110. However, when the amount of off-gassing of GH2 is insufficient, the fuel for fuel cells 108 will be supplemented through the LH2 pathway.

As previously discussed, the LH2 pathway to GH2 reservoir 110 begins with header tank 103, which is fed from LH2 storage tank(s) 101 by drainage pipe 102. Header tank 103 is substantially smaller than LH2 storage tank(s) 101 and, in a preferred embodiment, is built using double-wall vacuum construction to minimize the amount of off-gassing and reduce the complexity of managing a separate source of significant off-gassing during operation of the system. However, in an alternative embodiment, single wall construction of header tank 103 may be used to reduce overall weight. In either case, off-gassing from header tank 103 is managed through one of two flow channels. The first channel is through pipe 210, in which the off-gas is entrained by turbopump or compressor 104; and the second channel is through pipe 211 which connects the head space of header tank 103 with any one or more of LH2 storage tanks 101, thereby allowing pressure to equalize between tanks.

Between header tank 103 and GH2 reservoir 110, the cryogenic hydrogen must be warmed to an ambient temperature and pressurized to a level that is sufficiently higher than the maximum operating pressure of GH2 reservoir 110 to meet the required GH2 flow rate through fill pipe 106. Depending on operator preference, this may be achieved in several alternative ways.

In one alternative embodiment, turbopump or compressor 104 is utilized to pressurize LH2 from header tank 103 and through insulated pipe 204 into heat exchanger 105. In this embodiment, operation of turbopump or compressor 104 is regulated to attain the target flow rate in fill pipe 106, which fill rate may be determined by measuring the pressure in GH2 reservoir 110 or through other measured parameters including, but not limited to, the difference in mass flow from the GH2 pathway and the flow of GH2 to fuel cell(s) 108. As operating conditions change, such measurements are used as input variables to automated controls that maintain the target flow rate of GH2 in fill pipe 106 while minimizing the use of turbopump or compressor 104.

In an alternative preferred embodiment, LH2 storage tank(s) 101 and header tank 103 operate at a sufficient pressure to eliminate the need for turbopump or compressor 104 to provide the target flow rate in fill pipe 106 as the GH2 exits heat exchanger 105 at an ambient temperature and a sufficiently higher pressure than GH2 reservoir 110. In this embodiment, the flow rate is regulated by valves rather than by turbopump power, and sensors (not shown in the illustration) are used to monitor the pressure and boiloff rates of LH2 storage tank(s) 101, header tank 103, and GH2 recycle loop 113; and as operating conditions change, automated controls regulate such valves to attain the target flow rate in fill pipe 106.

Heat exchangers 105 and 115 may be composed of one or more stages to maximize the efficiency of heat transfer while raising the hydrogen temperature from around 21° K (−252° C.) to a temperature at or near standard ambient levels (288° K, or approximately 15° C. and 60° F.). The source of heat transmitted by the working fluid through pipes 109(a) and 109(b), respectively, is from fuel cell(s) 108 waste heat, again providing a virtuous cycle of raising the hydrogen temperature to ambient or near-ambient levels while providing cooling flows by working fluid carried through piping 107(a) and 107(b) back to fuel cell(s) 108.

As previously discussed, GH2 reservoir 110 is maintained at a pressure level that is sufficient to supply the fuel cell power system demand for hydrogen via one or more pipes 111 to fuel cell(s) 108 shown in FIG. 1. In addition, as shown, GH2 may be returned via return path 113 to pressurize LH2 storage tanks 101 when releasing LH2 from such storage tanks. Also, in a preferred embodiment, GH2 reservoir 110 can provide additional hydrogen to gas cells (e.g., ballons) for the airship through pipe 205 to provide added lift, or to remove hydrogen through pipe 206 from such gas cells during descent or to maintain neutral buoyancy during flight operations as described in Applicant's prior issued U.S. Pat. No. 8,336,810, which is incorporated herein by this reference (the '810 patent).

FIG. 2(b) shows another alternative embodiment that eliminates turbopump or compressor 104, insulated pipe 204, heat exchanger 105, and fill pipe 106 to supply GH2 reservoir 110, each shown in FIG. 2(a). In this alternative embodiment, a second off-gassing pathway is provided from header tank 103 to GH2 reservoir 110 through pipe 203 and heat exchanger 115. As shown, off-gas from header tank 103 is pumped through insulated pipe 212, which employs compressor 213 to pressurize the hydrogen off-gas to a higher pressure than the contents of pipe 203 and GH2 reservoir 110. In this optional embodiment, rather that managing the rate of off-gassing taking place in header tank 103 with pipes 210 and 211, as described with respect to FIG. 2(a), the rate of boiloff from header tank 103 in the system depicted in FIG. 2(b) may be controlled by recirculating GH2 drawn from GH2 reservoir 110 into header tank 103 through return pipe 214. In this alternative embodiment, this introduction of near-ambient temperature hydrogen from GH2 reservoir 110 will accelerate the rate of boiloff; and reducing the flow of such recirculated GH2 flow while simultaneously increasing the amount of LH2 introduced from LH2 storage tank(s) 101 through drainage pipe 102 will slow down the rate of such off-gassing. The flow rate of off-gas from header tank 103 to GH2 reservoir 110 is regulated by at least valve 215; the flow of near-ambient temperature GH2 recirculated into header tank 103 is regulated by valve 216; and check valve 217 controls the flow of LH2 from LH2 storage tank(s) 101 into header tank 103.

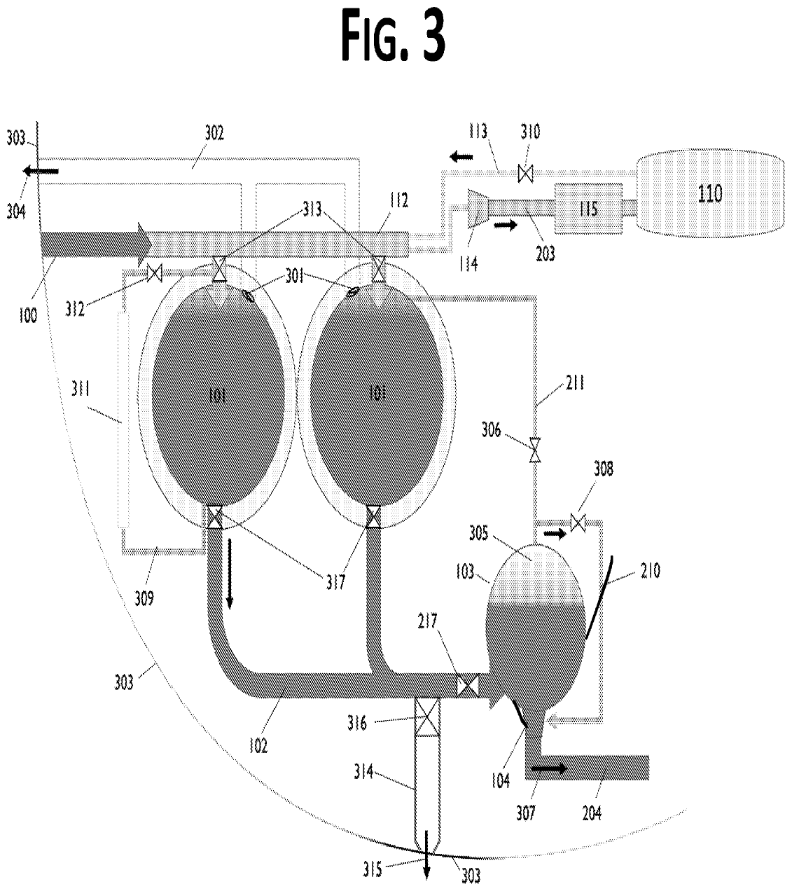

FIG. 3 presents additional details regarding the management and safety systems for the liquid hydrogen system disclosed in FIGS. 1 and 2(a). As illustrated therein, in a preferred embodiment, each of LH2 storage tanks 101 is equipped with an emergency over-pressure burst disk 301. Such burst disks 301 will rupture prior to the LH2 storage tank 101 in which they are installed to prevent the tank from being damaged by excessive pressure and will vent GH2 through vent pipe(s) 302, enabling the safe release of such vented GH2 outside the surface 303 of the airship, as indicated by arrow 304.

In one embodiment header tank 103 is partially filled with LH2 and expected to have a gaseous hydrogen head space 305 of approximately 20-40% of such tank's total volume. In this embodiment, this head space 305 is maintained by controlling the inflow and outflow of GH2 via two pathways. In one pathway, head space 305 is connected to the head space of the one or more LH2 storage tanks 101 via piping 211, which is regulated by valve 306 to enable the flow of GH2 in either direction depending on the relative tank pressures. In an alternative pathway, as shown in FIG. 3, head space 305 of header tank 103 is connected by pipe 210 to enable excess GH2 to be entrained by turbopump or compressor 104 in header tank 103's outflow (which outflow is designated by arrow 307) inside insulated pipe 204, such recycled GH2 flow being regulated by valve 308. In an alternative embodiment, header tank 103 contains only GH2 with the evaporation of the liquid hydrogen accomplished through use of a limited, single-stage heat exchanger (not shown in the figure) integrated with the header tank feed line 102. In either embodiment, the need for a turbopump or compressor 104 between header tank 103 and heat exchanger 105 (shown in FIG. 2(a)) will depend on the pressure maintained in header tank 103.

Once filled, in a well-managed operating environment, LH2 storage tanks 101 will generally operate at a pressure level that is higher than ambient conditions. Phase change of a small quantity of the LH2 to a gaseous header in such LH2 storage tank(s) 101 is expected to provide much, and in a preferred embodiment all, of the pressurization needed for operating the system. Should this level be insufficient to maintain pressure as such LH2 storage tank(s) 101 drains during flight, two alternate sources of pressurization are illustrated in FIG. 3. These alternate sources of pressurization are capillary return tube 309, and the GH2 reservoir 110 via the return path 113, which is regulated by the valve 310.

Capillary return tube 309 runs through ambient air heat exchanger 311 to evaporate the LH2 that was pulled from the bottom of one or more of LH2 storage tank(s) 101; and such GH2 is then piped back into the top of one or more of such LH2 storage tank(s) 101 at pressure provided by the phase change. As shown in FIG. 3, the flow through this circuit is regulated by control valve 312.

Return path 113 from GH2 reservoir 110 allows venting of ambient temperature, high pressure hydrogen back into the headspace of LH2 storage tank(s) 101, with the flow rate to manifold 112 regulated by at least valve 310 and the flow of such GH2 into any one or more of LH2 tanks 101 is optionally further regulated by valve 313. The additional heat provided by the injection of ambient temperature gas into such LH2 storage tank(s) 101 will also briefly increase the amount of boiloff, thereby providing a secondary increase in tank pressure. Similarly, in an optional alternative embodiment, heat can be added to or around at least one of the one or more LH2 storage tanks 101 to further increase the boiloff rate when and as needed to provide additional GH2 for such fuel cell(s) 108, as described with respect to FIG. 1.

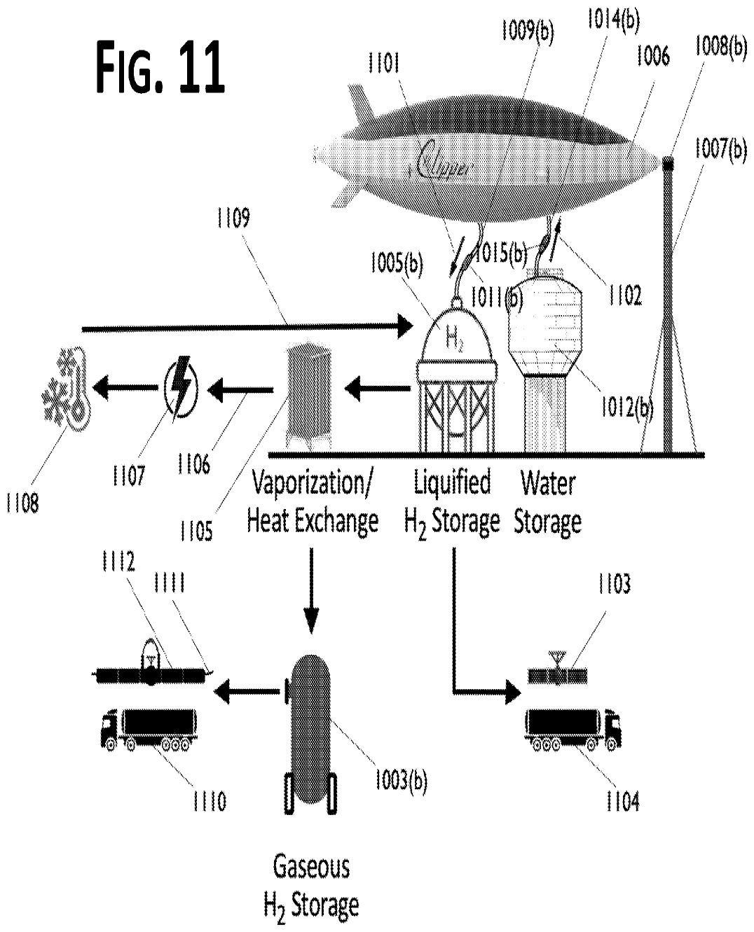

In the case of needing to empty one or more LH2 storage tanks 101—a frequent occurrence if the airship is being operated as a transport vehicle for LH2 as contemplated in Applicant's '810 patent—one or more insulated drain outlets 314 are provided to enable release of such LH2 outside the surface 303 of the airship, as indicated by arrow 315. Persons of ordinary skill in the art will understand that such drain outlet(s) 314 may connect with various pipes, hoses, and couplings to enable LH2 to flow into one or more external storage tanks such as Liquified H2 Storage tank 113(b) in FIG. 1(b) of the '864 patent corresponding to liquified H2 storage tank 1005(b) in FIG. 11 hereof, with the flow of LH2 through each of such one or more drain outlets 314 being regulated by corresponding outlet valve(s) 316, as further discussed with respect to FIG. 4. Each LH2 storage tank 101 is equipped with drainage valve 317, which enables selective control over the release of LH2 into drainage pipe 102. In addition, in a preferred embodiment, check valve 217 may be used in conjunction with outlet valve(s) 316 to selectively enable directional control of the flow of LH2 through drainage pipe 102 to drain outlet(s) 314 or header tank 103.

Turning next to FIG. 4, an innovative feature is disclosed for rapidly emptying LH2 storage tank(s) 101 such as when delivering such LH2 to a regional depot site or other destination. Persons of ordinary skill in the art will readily understand that in order to most efficiently drain LH2 storage tank(s) 101, the volume of LH2 to be drained therefrom needs to be replaced by GH2. In a preferred embodiment, the GH2 that is injected into the LH2 storage tank(s) 101 to be drained will be only marginally above the liquefaction temperature of 23° K to keep such LH2 storage tank(s) 101 in a cryogenic state, either for continued use as fuel on a return journey, or otherwise to minimize thermal cycles as well as the time and expense of preparing for the next time the tank is filled with cryogenic hydrogen. To accomplish both the rate of gas generation needed as well as to maintain the temperature of such LH2 storage tank(s) 101 in a cryogenic state, turbopump or compressor 104 and heat exchanger 105 are utilized. However, in this case, heat exchanger 105 only provides enough heat input to raise the temperature of the GH2 a few degrees above the liquefaction point, either through use of only the first stage of a multi-stage heat exchanger, or through reduction in the amount of waste heat input provided by the working fluid from fuel cell(s) 108 that is piped into such GH2 heat exchanger 105 through piping 109(a).

In order to rapidly drain LH2 storage tank(s) 101, exit valve 401 on GH2 transfer line 106 is closed, thereby blocking the flow of pressurized GH2 from heat exchanger 105 into GH2 reservoir 110. Low temperature gas exit valve 402 is then opened, thereby enabling the flow of pressurized GH2 (illustrated by arrow 403) from heat exchanger 105 into low temperature gas pipe 404, which may be a single wall insulated pipe or a vacuum jacket design pipe. The flow rate and temperature of such GH2 are modulated by turbopump or compressor 104, which is utilized to push LH2 from header tank 103 through insulated pipe 204 into heat exchanger 105 and the inflow rate of waste heat input by the working fluid from fuel cell(s) 108 piped into such heat exchanger 105 through piping 109(a) using an optional pump (not shown in the figure). Based on modulating these inputs, pressurized GH2 403 flowing through low temperature gas pipe 404 is maintained at a nearly cryogenic temperature when such gaseous hydrogen 403 is piped into manifold 112. Although not illustrated, it will be apparent how similar principles employing heat exchanger 115, return path 113, and control valves 216 and 310 may be used in conjunction with the alternative embodiment shown in FIG. 2(b).

By selectively opening and closing valves, one or more of LH2 storage tank(s) 101 can then be drained. As illustrated in FIG. 4, the LH2 content of just LH2 storage tank 101(a) may be drained by closing manifold exit valve 405 and check valve 217, while opening valve 313(a), drainage valve 317(a), and at least one outlet valve 316 while keeping valve 313(b) and drainage valve 317(b) closed. It will be apparent to persons of ordinary skill in the art that this method of selectively opening and closing valves can be used to cause one or more of LH2 storage tanks 101 to drain in an orderly manner.

The foregoing example illustrates how liquid hydrogen will be permitted to drain from LH2 storage tank 101(a)—but not LH2 storage tank 101(b)—through one or more drainage pipes 102 and drain outlets 314. As will be apparent to persons of ordinary skill based on this disclosure, such drainage is achieved by a combination of gravity, pressurization, and the replacement of cold gaseous hydrogen via pipe 404 (or, while not shown, via pipe 113 in the alternative configuration disclosed with respect to FIG. 2(b)) to boost the drain rate and/or to supply the LH2 needed to feed additional cold gas generation provided from header tank 103.

FIG. 4 also shows water storage tank 406 that is filled through piping 407 with water provided from one or more external water storage tanks through various pipes, hoses and couplings that are collectively represented by arrow 408 and more particularly described with respect to FIG. 11, and water produced as an effluent resulting from the typical operation of the one or more fuel cells 108. With respect to this second source of water, persons of ordinary skill in the art will understand that during normal operation, fuel cell(s) 108 will produce approximately 9 kilograms of pure water for each kilogram of GH2 they consume as fuel. Accordingly, to maintain neutral buoyancy of the airship during flight, one kilogram of water needs to be retained as ballast in water storage tank 406 for each kilogram of hydrogen consumed. Drain outlet 409, which is regulated by corresponding outlet valve 410, enables selective control over the release of such water. Although various outlet types are possible, in one embodiment, one or multiple spray heads 411 are used to ensure that this excess water is released in a sufficiently fine mist to be readily evaporated.

Water storage tank 406 also includes a second water drain 412 that is regulated by corresponding outlet valve 413 to enable release of stored water. Such water drain outlet 412 may be used for rapid release of water held as ballast in response to the loss of lifting gas from one of the gas cells during flight. In addition, as part of normal ground operations, such water drain outlet 412 may connect with various pipes, hoses, and couplings that are collectively represented by arrow 414 and which enable water to flow from water storage tank 406 into one or more external water storage tanks such as water storage tank 1014(a) in FIG. 10 hereof and discussed below with respect to such figure.

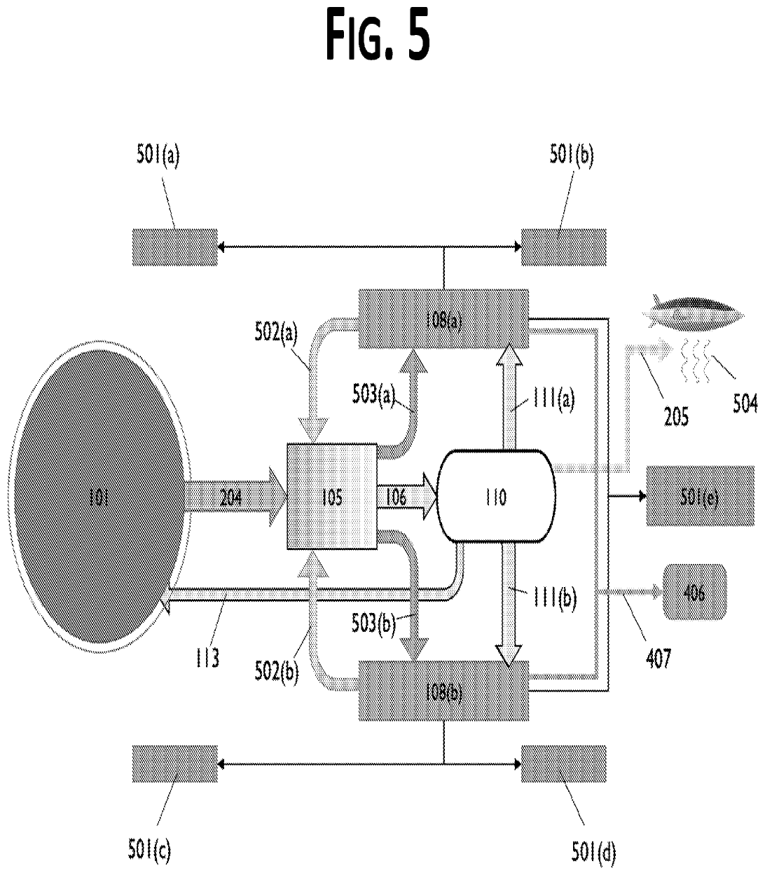

FIG. 5 illustrates how the hydrogen storage and thermal management system disclosed with respect to FIGS. 1-4 are integrated into a fuel cell electric powertrain for aircraft or airship propulsion. In FIG. 5, LH2 storage tank(s) 101 and the multiple pathways to GH2 reservoir 110 are simplified for overview purposes but are nevertheless intended to represent the fully functional system of pathways, controls, monitoring, and safety equipment, as previously disclosed. LH2 from LH2 storage tank(s) 101 is fed through insulated pipe 204 to one or more heat exchangers 105, and from there as GH2 via piping 106 into GH2 reservoir 110. Hydrogen fuel cells, shown in two parallel banks 108(a) and 108(b), receive gaseous hydrogen from GH2 reservoir 110 through inlet piping manifold 111(a) and 111(b). Fuel cells 108(a) and 108(b) in turn supply electrical power to propulsion motors 501(a)-501(d), two on each side of the craft, and 501(e), a fifth motor located in its stern. Hot piping 502(a) and 502(b), and return cold piping 503(a) and 503(b), respectively illustrate a virtuous cycle coolant loop rejecting waste heat from such fuel cells to warm the cryogenic hydrogen to ambient temperatures in heat exchanger(s) 105, while cooling fuel cells 108(a) and 108(b) so they operate in the optimal performance range. Piping 407 takes water effluent produced by fuel cells 108(a) and 108(b) to water storage tank 406, where in order to maintain neutral buoyancy, one kilogram of water is retained for each kilogram of hydrogen used and the remainder is dispersed into the atmosphere. In a preferred embodiment, GH2 from GH2 reservoir 110 also pressurizes LH2 storage tank(s) 101 through return path 113 and provides supplemental lifting gas to the airship gas cells through pipe 205 as needed to adjust buoyancy 504.

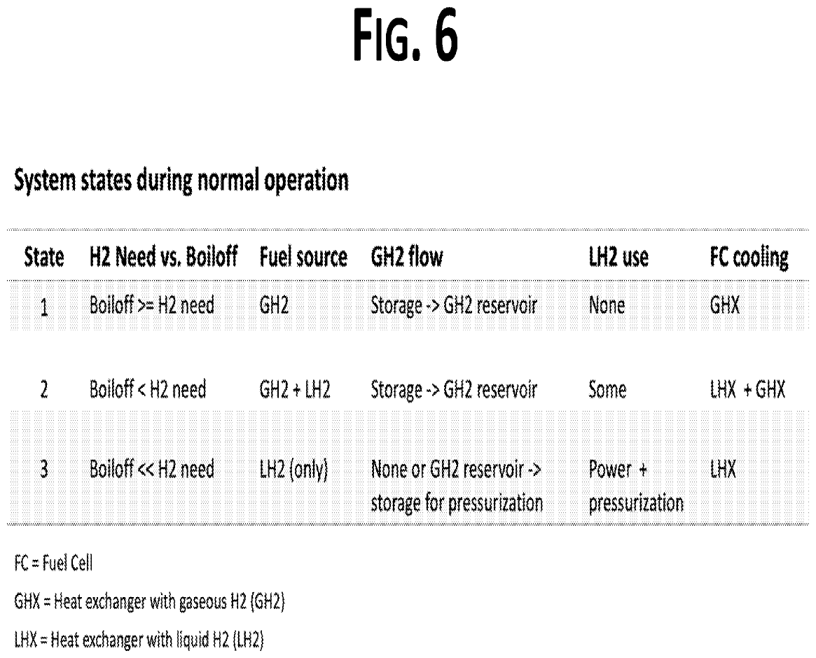

The architecture described in FIGS. 1-5 provides an exemplary implementation of an apparatus for low weight liquid hydrogen storage, pressurization, heating, and utilization on aircraft and airships. As has been described, there are multiple pathways from the storage tanks to the gaseous hydrogen reservoir, as well as multiple options for pressurization and heating of the hydrogen prior to its use as fuel. Although these various options have not been illustrated, it will be apparent to persons of ordinary skill in the art how the disclosed principles may be employed respecting each of such alternative pathways, including without limitation the alternative embodiment incorporating heat exchanger 115 and pipes 203 and 212 disclosed in FIG. 2(b). FIG. 6 provides a set of system states which determine how much hydrogen will flow through the GH2 and LH2 pathways based on the rate of off-gassing.

As shown therein, in “State 1”, the quantity of boiloff produced from LH2 storage tank(s) 101 equals or exceeds the amount of gaseous hydrogen that is required for fuel cell(s) 108 to satisfy the power requirements for electric engines 501(a)-501(e). In this state, sufficient gaseous hydrogen flows in the previously described manner from LH2 storage tank(s) 101 to GH2 reservoir 110 such that all of the power needs of the airship or aircraft are addressed without supplementation from liquid hydrogen reserves, and fuel cell(s) 108 are able to be cooled through GH2 heat exchanger 115. Persons of ordinary skill in the art will readily appreciate that within reasonable operating ranges, the amount of engine thrust and auxiliary power requirements can be adjusted to consume the boiloff produced and simultaneously to assure that GH2 reservoir 110 provides for adequate storage of hydrogen for fuel without the need for venting (and thereby wasting) any excess boiloff. All other conditions being equal, in a preferred embodiment, the optimal range of operation for an airship as described in Applicant's prior '810 patent will have a cruising speed averaging between 125 mph and 200 mph.

FIG. 6 also indicates two operating states in which the production of gaseous hydrogen must be increased to address the power requirements of the airship or aircraft. As shown therein, in so-called “State 2”, the quantity of boiloff produced from LH2 storage tank(s) 101 is less than the gaseous hydrogen required for fuel cell(s) 108 to satisfy the power requirements for electric engines 501(a)-501(e); and in “State 3”, the quantity of boiloff produced is substantially less than required. In State 2, fuel cell(s) 108 are cooled through both GH2 heat exchanger 115 and LH2 heat exchanger 105.

In State 3, wherein the rate and quantity of boiloff produced is substantially less than adequate to replenish the gaseous hydrogen in GH2 reservoir 110 and provide adequate power for electric engines 501(a)-501(e), the pressure in header tank 103 and, if needed, supplementation with turbopump or compressor 104, is used to move liquid hydrogen through insulated pipe 204 to LH2 heat exchanger 105 and to cool fuel cell(s) 108. In the alternative configuration disclosed with respect to FIG. 2(b), such supplementation, if needed, is achieved by increasing the flow of ambient or near ambient GH2 from GH2 reservoir 110 through return pipe 214 to accelerate the rate of off-gassing in header tank 103; and this additional boil-off is moved through pipe 212 to heat exchanger 115.

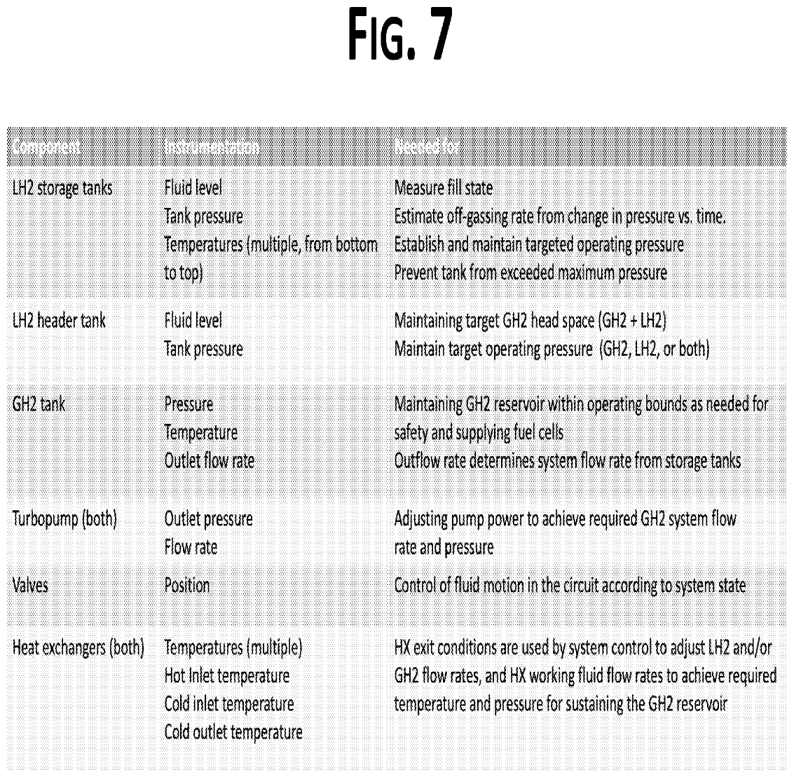

Turning to FIG. 7, a non-limiting list of instrumentation and sensors is provided that is useful in a preferred embodiment to effect the foregoing operating states with the actual movement of hydrogen through the system. These sensors are used to measure the operating parameters of the primary components listed in FIG. 7 as well as actuated hardware including pumps and valves depicted in FIGS. 4 and 5, all of which are used to control the flow of hydrogen through the previously disclosed piping therein illustrated. In a preferred embodiment, a set of control algorithms utilizes information received from these sensors to open and close these valves and adjust the speed of turbopumps or compressors 104 and 114 based on heuristics and feedback loops to achieve the target operating state.

The control algorithms are designed to configure the system to achieve the following operating state objectives in order to achieve the desired system performance while operating safely within the limits of all system components:
a. Maintain the pressure and temperature of GH2 reservoir 110 to be within operating limits for supplying hydrogen to fuel cell(s) 108.
b. Maintain the pressure of storage tank(s) 101 to be within the target operating range.
c. Maintain the pressure and (if required) head space 305 in header tank 103 to be within a pre-determined operating range, for example a headspace of 20-40% of such tank's volume.
d. Maximize utilization of waste heat from fuel cell(s) 108 in the one or more heat exchangers 105 and 115 while returning low temperature coolant to fuel cell(s) 108.
e. Ensure that there is no venting of excess boiloff by controlling the speed and thrust levels of electric engines 501(a)-501(e) as well as the controllable power demand for other auxiliary systems to ensure consumption of LH2 is equal or greater than the rate of boiloff.
f. In addition to a steady state prevention of boiloff as disclosed in the preceding objective, the control system will also apply forward looking algorithms to minimize boiloff during the docking and load/unload phases of operation described with respect to FIGS. 10 and 11. For example, while approaching the end of the cruise leg but prior to reducing power and hence GH2 consumption rate, the system will reduce pressure in all tanks to the minimal operating pressure in order to have the maximum margin for retaining boiloff by building pressure during times of low GH2 consumption. In another non-limiting example, electrical resistive load banks may be used to produce heat and simultaneously regulate power consumption rather than venting excess boiloff.

In a preferred embodiment, information regarding the current state of the components of the system shown in FIG. 7 is collected on a continuous basis during operation of the airship or aircraft such that the change in various parameters over time can be used to calculate the rates of change in parameters such as the rate of LH2 fluid usage, or the rate of off-gassing buildup in LH2 storage tank(s) 101 based on the change in tank pressure. These data may be measured directly or derived from other instrumentation. For example, the change in pressure across turbopump or compressor 104 or 114 may be used to derive the flow rate through the pump without needing to measure the fluid flow directly. As another example, the power level of fuel cell(s) 108 may be used to closely approximate the flow rate of GH2 that needs to be provided to GH2 reservoir 110 without measuring this flow directly.

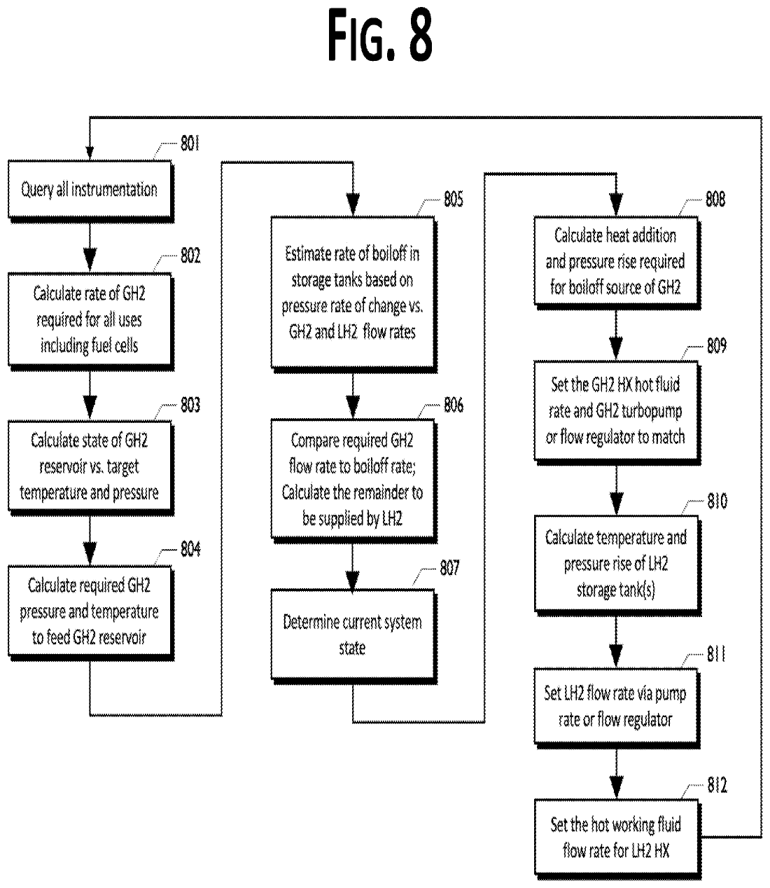

Turning next to FIG. 8, a block flow diagram is provided to show the steps used by the previously disclosed control system algorithms to maintain GH2 reservoir 110 at a specified pressure and temperature while managing the utilization of liquid hydrogen from LH2 storage tank(s) 101 in a safe and efficient manner. Rectangular box 801 indicates that the system queries all instrumentation including, but not limited to the instrumentation listed in FIG. 7; and from the data received by the system in response thereto, conducts a series of calculations, the results of which are used to issue commands to system control hardware, including without limitation the previously disclosed valves and pumps in order to achieve the desired result. Rectangular box 802 indicates calculation of the flow rate of GH2 required by GH2 reservoir 110 to supply fuel cells 108 and any other ancillary power requirements. Rectangular box 803 indicates calculation of the current state of GH2 reservoir 110 and comparison of this state with a target state, such targeted state consisting of, but not limited, the reservoir pressure and temperature.

Rectangular box 804 indicates a calculation in which the results of the calculations in steps 802 and 803 are utilized by an algorithm to calculate the target input temperature and pressure needed to reach or maintain the target state. Such algorithm includes, without limitation, direct computation of fluid mechanics of inflow and outflow of compressible fluids; and the computation of outflow (GH2 use) may include the operating efficiency of fuel cell(s) 108, and the power requirements of electric engines 501(a)-501(e) based on the commanded power level of the propulsion power system and other controllable auxiliary power requirements. Further, such algorithm may optionally include heuristics relating to the response of the overall system in order to improve control accuracy and prevent overshoots or other undesirable oscillations in system state. Rectangular box 805 indicates a computation in which the change in pressure in each LH2 storage tank 101 is compared with the rate of flow out of the tank(s), and from which the actual boiloff rate is calculated. Rectangular box 806 indicates a computation in which the rate of boiloff ascertained in step 805 is compared to the rate of use of GH2 calculated in step 804; and from which the algorithm calculates the additional LH2 needed to meet overall system requirements and in turn to derive the quantity of fuel that will be supplied through direct use of LH2. Rectangular box 807 indicates the comparison of the GH2 and LH2 rates ascertained in accordance with step 807 with the system operating state definitions in FIG. 6 and determination of the operating state.

The operating state is then used by the system to apply the correct heuristics to the control algorithms. Persons of ordinary skill in the art will appreciate that the system response to these inputs occurs over a relatively long time period; is asynchronous to the time period in which the actual change in the rate of boiloff occurs; and takes place in a different time scale when the hydrogen source is boiloff gas, liquid hydrogen in LH2 storage tank(s) 101, and/or the contents of header tank 103. Accordingly, these factors result in different heuristics for each of these operating states and hydrogen sources. Persons of ordinary skill in the art will appreciate how, in light of the foregoing disclosures, these heuristics can be used in a well-ordered system to predict the system response to the previously described control system inputs and in turn in order to accelerate the speed up convergence on the desired operating state while minimizing excess off-gassing. These heuristics are utilized in the calculations described in steps 808 and 810.

Rectangular box 808 indicates a calculation to determine the increase in pressure and temperature of the GH2 source prior to reaching GH2 reservoir 110. Rectangular box 809 indicates a calculation that translates the results of step 808 into system hardware commands including, but not necessarily limited to, the hot fluid flow rate for heat addition in GH2 heat exchanger 115 as well as the cold gas GH2 flow rate. In a system in which the pressure in LH2 storage tank(s) 101 (and associated cryogenic boiloff gas) is lower than the necessary operating pressure, this command operates turbopump or compressor 114, while in a system in which the pressure in LH2 storage tank(s) 101 is at or higher than the needed pressure, the flow rate is set by a flow regulator (valve).

Rectangular box 810 conducts similar calculations as step 808 for the LH2 source and heat exchanger 105. Rectangular box 811 translates these calculations into the pressure needed in LH2 pathway 204 prior to LH2 heat exchanger 105 such that the final pressure matches the target pressure calculated in step 804. In a system in which the pressure in LH2 storage tank(s) 101 and header tank 103 is lower than the required operating pressure, this command operates turbopump or compressor 104, while in a system in which the pressure in LH2 storage tank(s) 101 and header tank 103 is at or higher than the needed pressure, the flow rate may be set by a flow regulator (valve). Finally, rectangular box 812 uses the results of step 810 to calculate the hot working fluid flow rate through LH2 heat exchanger 105 such that the output GH2 temperature matches the target temperature and pressure calculated in step 804.

As illustrated by the connection between steps 812 and 801 in the flow path depicted in FIG. 8, this process operates on a continuous basis to maintain GH2 reservoir 110 at a specified pressure and temperature while managing the utilization of liquid hydrogen from LH2 storage tank(s) 101 in a safe and efficient manner, Additional control algorithms include direct computations as well as use of heuristics to implement changes in valve positions, pump flow rates, and coolant flow rates to keep all components of the system operating within the target state, such state being determined by operator command. In a preferred embodiment, the control algorithms are designed to utilize boiloff gas as the first and primary source of hydrogen for fuel, while making up any difference in available boiloff gas to required GH2 by use of LH2. Also in a preferred embodiment, an intuitive system such as a “traffic light system” is provided to alert the operator when the system is operating within specified ranges (“green”), when it is approaching a limit (“yellow”), and when it is out of specification and/or in a dangerous condition (“red”) where manual intervention may be dictated.

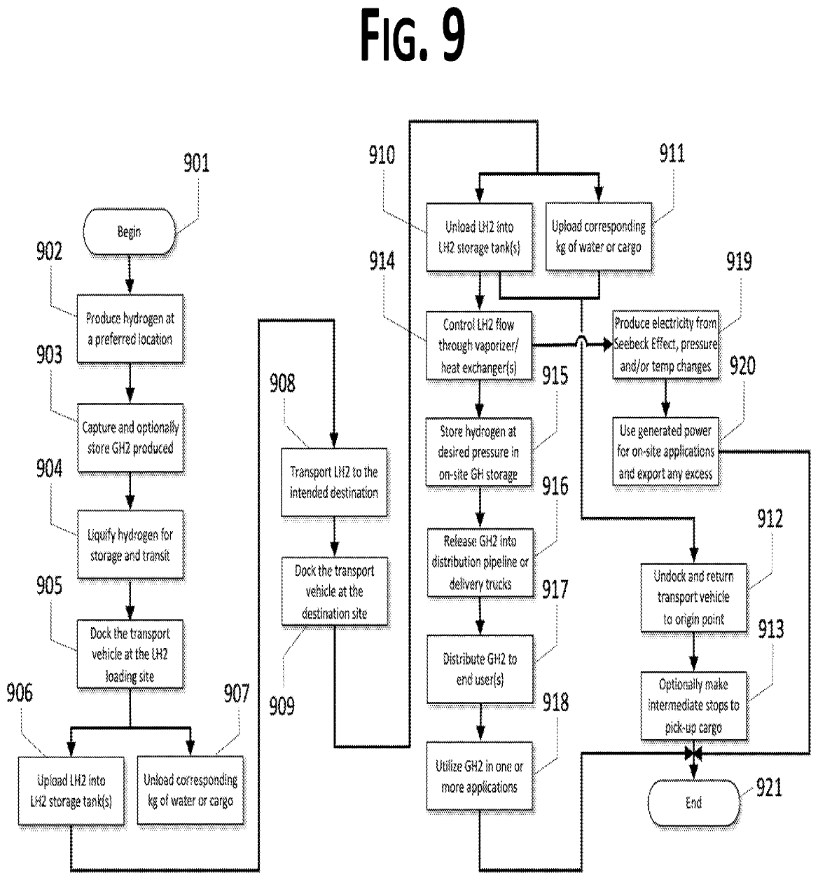

Turning next to FIG. 9, a block flow diagram is presented that illustrates a method within a preferred embodiment of the subject technology for interconnecting a hydrogen transport vehicle incorporating the previously disclosed technologies with ground-based operations. As shown therein, oval 901 represents the beginning of this method at a geographic location where hydrogen is produced for export. The production of such hydrogen is represented by rectangular box 902, generally corresponding to rectangular box 202 in FIG. 2 of Applicant's '864 patent. Once produced, such hydrogen is captured and optionally stored in gaseous form, as represented by rectangular box 903, before being liquified in step 904 for the purposes of storage and transport.

Rectangular box 905 indicates the step of an airship or other transport vehicle docking at the site designated for loading such liquid hydrogen. Once properly secured, when the transport vehicle is an airship, steps 906 and 907 are undertaken approximately simultaneously in order to maintain neutral buoyancy of the craft within reasonable tolerances determined by the system operator. Rectangular box 906 designates that liquid hydrogen is loaded into LH2 storage tank(s) 101 on the transport vehicle from one or more external storage tanks at such location, which occurs through the coupling represented by arrow 100 in FIG. 1. The weight represented by loading such liquid hydrogen is offset by unloading a corresponding amount of water or cargo, as represented by rectangular box 907. Once such loading operation is complete, the transport vehicle undocks and travels to the intended destination for delivering such liquid hydrogen. This step is represented by rectangular box 908, generally corresponding to rectangular box 208 in FIG. 2 of Applicant's '864 patent; and upon arrival at the intended destination for the hydrogen, the transport vehicle is properly secured, as indicated by rectangular box 909.

When the transport vehicle is an airship, steps 910 and 911 are undertaken approximately simultaneously in order to maintain neutral buoyancy of the craft within reasonable tolerances. Rectangular box 910 designates that liquid hydrogen is drained (or pumped if necessary) from LH2 storage tank(s) 101 into one or more external storage tanks at such location through the flow represented by arrow 315 in FIG. 3. The weight reduction resulting from unloading such liquid hydrogen is offset by loading a corresponding amount of water or cargo into the transport vehicle, as represented by rectangular box 911. Once such operation is complete, the transport vehicle undocks and returns to the point of origin to pick up the next delivery of liquid hydrogen. This step is represented by rectangular box 912. Optionally, the transport vehicle may make one or more intermediate stops while in route; in which case, water that was loaded as ballast in step 911 is removed and a corresponding weight of cargo is loaded onto the transport vehicle, or vice versa, which is represented by rectangular box 913. Oval 921 designates the end of the method from the perspective of the transport vehicle, and once back at the point of origin corresponding to step 905, the foregoing steps may then be repeated.

At the destination location, liquid hydrogen that was delivered into external LH2 storage tanks in step 910 is managed in order to match the demand for liquid or gaseous hydrogen or both. It will be apparent to persons of ordinary skill in the art that the destination location may provide hydrogen for use by a single, large user such as a heavy industrial company or electric utility company requiring the hydrogen as feedstock for producing products such as steel, cement or electricity; or the destination location may be a strategically located facility, referred to herein as a “depot”, to supply hydrogen to multiple end-user locations and for a multitude of different applications generally corresponding to rectangular boxes 220, 221, 222 and 224 in FIG. 2 of Applicant's '864 patent. For the purposes of illustration but not limitation, FIG. 9 and FIG. 11 describe the destination for a depot that serves as a hub for the distribution of GH2 and LH2 to such end-user locations; and it will be apparent that portions of the described system and method may be omitted or differently sized when the destination location is a single user.

Rectangular box 914 designates the process of managing the flow of liquid hydrogen through one or more vaporizer/heat exchange units in order to warm the hydrogen to a desired temperature and pressure level. Rectangular box 914 incorporates the processes and apparatus involving pumps, valves, and heat exchangers disclosed in FIGS. 1-5. Moreover, by way of enhancement rather than limitation, several added processes may be incorporated in a preferred embodiment due to the fact that the weight of containment vessels is not as critical for ground-based facilities as in a transport vehicle; because the purpose of the ground-based depot will be principally to offload, temporarily store, and then distribute hydrogen rather than consume it on site; and because in such cases the ground facilities will not employ the same relative proportion of fuel cells (and thereby are not likely to produce the same relative quantity of waste heat) as a transport vehicle.

For these and other reasons that will be apparent to persons of ordinary skill in the art, the vaporization/heat exchanger units employed in such ground facilities are likely to be significantly larger and to employ largely ambient air applied over a much greater surface area to warm the LH2, and the pressure levels at which GH2 is stored at the destination location are likely to be substantially higher than GH2 reservoir 110. Rectangular box 915 depicts the storage of gaseous hydrogen in on-site storage. Such storage at scale may be in-situ such as in salt caverns, injected into abandoned wells, held in tanks of various sizes, stored in spools of FRP pipe as disclosed with respect to illustration 313 of FIG. 3(b) in Applicant's '864 patent, and by other storage means. Although the system operator will establish the desired pressure level for such ground-based storage facilities, in one preferred embodiment of a depot site, GH2 storage is between 172 bar (2500 psi) and 206 bar (3000 psi) in order to make it possible to inject into ASME codified distribution pipes for GH2 up to 2500 psi. The release of GH2 into one or more such distribution pipelines, and alternatively loading such GH2 into delivery trucks, is illustrated by rectangular box 916.

Rectangular box 917 indicates that through such means, gaseous hydrogen is delivered to various end users, corresponding to the hydrogen distribution represented by arrows 119(a)-119(e) of FIG. 1(b) in the '864 patent. Rectangular box 918, corresponding to end uses such as illustrated in FIG. 1(b) and rectangular boxes 220-223 and 225 of said '864 patent, illustrates the consumption of such GH2 in one or more applications, following which this portion of the method illustrated by FIG. 9 ends at oval 921, following which such hydrogen must be replenished by repeating the foregoing steps.

It is broadly understood that liquefying hydrogen requires high amounts of energy both for pre-cooling the hydrogen gas and the liquefaction process itself. When viewed from an energy balance perspective, this substantial amount of energy required to cool hydrogen below its boiling point is frequently cited as a reason for favoring alternatives such as ammonia and liquid organic hydrocarbon compounds (LOHC) to LH2 as an export commodity. However, when liquification occurs at a location where renewable energy is abundant and exceedingly inexpensive per kWh, and the LH2 is transported to a location where energy is much more costly per kWh, there exists an opportunity in a well-ordered system to recover a substantial portion of the liquification investment. In an optional preferred embodiment, as the LH2 is vaporized into its gaseous form before distribution and use, the method enables recovering some portion of the energy “investment” made in the previous liquification step. In this regard, rectangular box 919 designates that in a preferred embodiment, electricity is generated as a byproduct of how the vaporizer/heat exchanger unit(s) of step 914 are designed, configured, and operated.

By way of example rather than limitation, three methods of electricity generation are designated by rectangular box 919. The reference therein to the Seebeck Effect, which is the working principle of a thermocouple, designates the opportunity using well-known means to persons of ordinary skill in the art to produce electricity by joining at two junctions in a closed-circuit embodying dissimilar metals that are maintained at different temperatures. U.S. Pat. No. 7,992,670 to Rainer Richter et al. ('670 patent) discloses a motor vehicle with a drive assembly that is operated by a cryogenically stored fuel that comes into contact with the cold side of a thermo-electric generator to produce electric current for the electric power supply of said vehicle. In the herein disclosed system, an optional feature is the use of a thermoelectric generator to produce electric energy from the substantial difference between the temperature of −252.9° C. at which the LH2 is received and stored in step 910 and the ambient or near-ambient temperature at which GH2 is stored in step 915.

The reference within rectangular box 919 to pressure change designates the opportunity using well-known means to persons of ordinary skill in the art to produce electricity using a mechanical apparatus such as a piston, turbine, or other known means powered by the pressure that is built up as the hydrogen expands as its temperature rises. As the hydrogen gas becomes progressively warmer, unless constrained by the structure of the vessel in which it is contained, the gas will naturally expand by a factor of approximately 800 by the time it has transformed from a liquid to gaseous state, and its temperature rises from −252° C. to ambient levels. Alternatively, when constrained by the vessel in which the gaseous hydrogen is contained, this expansion will result in a buildup of pressure inside such tank, which pressure can in turn apply force to another object such as a dynamo to convert this mechanical energy into electrical energy using known methods. Accordingly, in this optional feature of the disclosed method, a cascade of tanks and valves is employed that will permit the pressure to build up to prespecified levels before being released in a controlled manner to a down-stream tank, with the release of such mechanical energy being converted into electrical power.

The reference within rectangular box 919 to temperature change designates the additional opportunity to produce electricity using the “natural draft” that can be created at the inlet for ambient air running across the much cooler coils or fins in one or more vaporization/heat exchange units that are used to warm the LH2 to ambient temperature. The temperature difference between the outside air and the air in the chamber in which these coils or fins are located creates this natural draft; and by adjusting the volume of the chamber, the inlet duct length and diameter, and then running this air over a fan blade at the inlet, this air flow can be converted into electrical power using well-known means to persons of ordinary skill in the art.

Rectangular box 920 represents the use of the power generated from these one or more optional sources for on-site power production, including without limitation providing electricity to a refrigeration unit that maintains one or more hydrogen storage tanks at the required temperature level, with any excess of on-site generated power able to be exported for use by others. Oval 921 designates the end of the method from the perspective of such optional recovery of a portion of the energy “investment” made in step 904 to liquify the hydrogen for more efficient transport, following which the foregoing steps repeat as more LH2 is introduced into the system.

FIG. 10 is a schematic diagram depicting the production and loading of liquid hydrogen onto the hydrogen transport vehicle at the point of origin, corresponding to a location where, as defined in step 902 of FIG. 9, hydrogen is produced for export. It is broadly understood that hydrogen can be produced by a variety of methods including methane reformation, coal gasification, and electrolysis powered by any number of energy sources. By way of example but not limitation, hydrogen gas 1001 is produced through electrolysis using one or a plurality of electrolyzers 1002 by passing an electrical current through an anode (+) and cathode (−) suspended in water to release oxygen (O2) and hydrogen (H2) molecules. Hydrogen 1001 that is produced may be stored as gaseous hydrogen in storage container 1003(a); liquefied with liquefaction system 1004; and stored as cryogenic hydrogen in storage container 1005(a). Although illustrated as a large ball-like structure, persons of ordinary skill in the art will appreciate that such cryogenic hydrogen storage 1005(a) may employ various underground and above-ground storage tanks.

In a preferred embodiment, airship 1006 arrives at or nearby the location (corresponding to step 905) where such cryogenic hydrogen storage 1005(a) is located; and is secured at a mooring device or structure 1007(a). As shown, such mooring device or structure 1007(a) is optionally equipped with a gimble 1008(a) on or near its top that can swivel to any angle, as disclosed in Applicant's prior U.S. Pat. No. 8,820,681 (the '681 patent), to enable airship 1006 to align itself with the prevailing wind. Flexible pipe 1009(a) which in one preferred embodiment is a segmented double-wall vacuum jacketed pipe, is coupled with airship 1006 and with said cryogenic hydrogen storage 1005(a) to enable LH2 to be pumped into manifold 112 of said airship 1006, as illustrated by arrow 100 in FIG. 1 and arrow 1010 in FIG. 10.

The initial flow of LH2 from cryogenic hydrogen storage tank(s) 1005(a) will rapidly vaporize in the process of cooling the transfer line to cryogenic temperatures. Accordingly, in a preferred embodiment, a ‘purge gas’ is directed by the airship system into the GH2 manifold 112 and from there into either LH2 storage tank(s) 101 or GH2 reservoir 110 in order to avoid venting any GH2 to the environment. Once flexible pipe 1009(a) has sufficiently chilled such that LH2 is reaching the airship, a valve will route the LH2 through manifold 112 and LH2 piping 102 for the remainder of the fill cycle. Also in a preferred embodiment, flexible pipe 1009(a) contains a secondary GH2 line (not shown) for removing any excess boiloff produced from LH2 storage tank(s) 101 and header tank 103 while the airship is secured at mooring device or structure 1007(a) so this GH2 is captured and productively used or recycled to the LH2 liquefaction system rather than being vented to the atmosphere or otherwise wasted.

In a preferred embodiment, flexible pipe 1009(a) is equipped with safety release valve 1011(a) to assure that no LH2 or GH2 escapes when said LH2 flow 1010 stops, whether this occurs at the end of a loading sequence or should the normal flow of LH2 be discontinued for any reason, including without limitation because an abrupt movement of airship 1006 or local conditions make continued loading of LH2 impractical or unsafe. Such safety release valve 1011(a) is also useful to making it possible using known means to persons of ordinary skill in the art for any residual LH2 and/or GH2 remaining in flexible pipe 1009(a) to be safely purged from such pipe once the coupling between airship 1006 and cryogenic hydrogen storage 1005(a) is discontinued, whether in the normal course of operations or in an emergent situation.

As previously described, in order to maintain neutral buoyancy of airship 1006 while loading LH2 or freight being picked up from such location, an equivalent weight of water or other ballast must be released. Accordingly, in a preferred embodiment, the location where such airship 1006 loads LH2 into cryogenic hydrogen storage 1005(a) will be proximate to one or more water storage tank(s) 1012(a). Although illustrated in FIG. 10 as a water tower structure, persons of ordinary skill in the art will appreciate that such water storage tank(s) 1012(a) may employ various underground and above-ground storage tanks. In addition, in an optional embodiment, it may be preferable for airship 1006 to land on or over water such as a lake, the ocean, or a pool built to accommodate such landings, and for such water ballast to be released directly into such body of water rather than a tank structure. Accordingly, for the purposes of this disclosure, all such alternative embodiments are included within the non-limiting term “water storage tank(s).”

Water flows in the direction indicated by arrow 1013 through flexible water pipe 1014(a), which couples water storage tanks (not shown) located on airship 1006 with such water storage tank(s) 1012(a). It is understood that the routing of water pipe 1014(a) may take any number of paths from the airship to reach the ground-based storage, including but not limited to routing through the airship nose to the docking structure 1007(a) or a connection to airship 1006 some distance from the said docking structure 1007(a), as illustrated, in order to reduce the vertical travel needed for the water. In a preferred embodiment, flexible water pipe 1014(a) is equipped with safety release valve 1015(a) to assure that no water escapes when said water flow 1013 stops, whether this occurs at the end of an LH2 and/or freight loading sequence or should the normal flow and/or freight loading operation be discontinued for any reason, including without limitation because an abrupt movement of airship 1006 or local conditions make continued loading of LH2 and/or freight impractical or unsafe.

Although flexible pipe 1009(a) and flexible water pipe 1014(a) are respectively illustrated as being coupled at the top of cryogenic hydrogen storage 1005(a) and water storage tank 1012(a), in an alternate embodiment, one or both of such flexible pipes may be coupled with such storage facilities at any point and/or be contained as an integral part of mooring device or structure 1007(a). For reasons that will be apparent to persons of ordinary skill in the art, the option of locating the coupling point within mooring device or structure 1007(a) will allow airship 1006 to align freely with the wind while maintaining a single, point of connection with the pipes. However, routing LH2 and water through the nose will add weight to said airship 1006, and in another embodiment, the LH2 pipe(s) 1009(a) and flexible water pipe 1014(a) will couple with airship 1006 near where the corresponding LH2 storage tank(s) 101 and on-board water tank(s) are located. In each alternative, it will be preferable that the insulation, much of the weight of such flexible piping, and reinforcing structure or articulated arms holding such flexible piping, to be permanently built into such mooring device or structure 1007(a) or supported from one or more ground-based gantries that extend up to the connection point in the alternative embodiment where the connection point is closer to the tank locations on airship 1006. It will also be apparent to persons of ordinary skill how the previously disclosed thermal control system, method and apparatus for providing cold working fluid and warm waste heat may be used to maintain flexible LH2 pipe 1009(a), water pipe 1014(a), and/or mooring device and/or structure 1007(a) at the appropriate temperature by coupling such equipment with pipes 107(a) or 107(b), and 109(a) or 109(b), when airship 1006 is being loaded or unloaded.

Turning next to FIG. 11, a schematic diagram is presented that illustrates the unloading of liquid hydrogen from the hydrogen transport vehicle at the destination, corresponding to a location where hydrogen is imported, and steps 910 through 921. In a preferred embodiment, airship 1006 arrives at or nearby the location (corresponding to step 909) where such cryogenic hydrogen storage 1005(b) is located; and is secured at a mooring device or structure 1007(b). As shown, such mooring device or structure 1007(b) is optionally equipped with a gimble 1008(b) on or near its top that can swivel to any angle to enable airship 1006 to align itself with the prevailing wind. Flexible pipe 1009(b) which, in one preferred embodiment, is a segmented double-wall vacuum jacketed pipe, is coupled with airship 1006 at one end and with said cryogenic hydrogen storage 1005(b) at the other to enable LH2 to drain or be pumped from one or more insulated drain outlets 314 of said airship 1006, as illustrated by arrow 315 in FIG. 3 and arrow 1101 in FIG. 11.

As previously disclosed, a purge gas is initially directed by the airship system into piping 102 and drain pipe 314; and once flexible pipe 1009(b) is sufficiently chilled, then valve 314 may be opened to permit the flow of LH2 into cryogenic hydrogen storage tank(s) 1005(b) for the remainder of the unload cycle. In a preferred embodiment, flexible pipe 1009(b) is equipped with safety release valve 1011(b) to assure that no LH2 escapes whenever said LH2 flow 1101 stops, whether this occurs at the end of an unloading sequence or should the normal flow of LH2 be discontinued for any reason, including without limitation because an abrupt movement of airship 1006 or local conditions make continued unloading of LH2 impractical or unsafe. Such safety release valve 1011(b) is also useful to making it possible using known means to persons of ordinary skill in the art for any residual LH2 remaining in flexible pipe 1009(b) to be safely purged from such pipe once the coupling between airship 1006 and cryogenic hydrogen storage 1005(b) is discontinued, whether in the normal course of operations or in an emergent situation.

Similar to the loading operation described with respect to FIG. 10 (but in reverse), in order to maintain neutral buoyancy while LH2 or freight are being unloaded at such location, an equivalent weight of water or other ballast must be pumped into tanks located in airship 1006. Accordingly, in a preferred embodiment, the location where such airship 1006 unloads freight and/or LH2 into cryogenic hydrogen storage 1005(b) will be proximate to one or more water storage tank(s) 1012(b). This water flows in the direction indicated by arrow 1102 through flexible water pipe 1014(b), which couples such water storage tank(s) 1012(b) at one end with storage tanks (not shown) located on airship 1006 at the other. For the reasons that have been described, flexible water pipe 1014(b) is equipped with safety release valve 1015(b).

As previously disclosed, the routing of LH2 flexible pipe 1009(b) and water pipe 1014(b) may take any number of paths from airship 1006 to reach the corresponding ground-based storage tank(s), including but not limited to routing the flow of LH2 and water, respectively, to move through the airship nose to mooring device or structure 1007(b) or a connection to airship 1006 some distance from the said docking structure 1007(a), as illustrated, in order to reduce the vertical travel needed for such LH2 and water from the respective tanks within airship 1006. Also in a preferred embodiment, flexible pipe 1009(b) contains a secondary GH2 line (not shown) for removing any excess boiloff produced from LH2 storage tank(s) 101 and header tank 103 while the airship is secured at a mooring device or structure 1007(b) so this GH2 is captured and productively used or stored rather than being vented to the atmosphere or otherwise wasted.

To the extent one or more users for liquified hydrogen are served from this depot, once the desired quantity of hydrogen has been unloaded from airship 1006 or an alternative means of bulk LH2 supply such as a pipeline or ship, LH2 may be released from cryogenic hydrogen storage tank(s) 1005(b) into one or more LH2 pipelines 1103 or trucks 1104 for delivery to such user(s). Alternatively, to serve end use markets for gaseous hydrogen, LH2 is released from cryogenic hydrogen storage tank(s) 1005(b) into one or more vaporization units 1105 that permit such hydrogen to warm to ambient temperature (and correspondingly expand as previously disclosed).

Arrow 1106 designates the production of electric power 1107 through thermo-electric generation, the conversion of mechanical energy and/or the natural draft into electrical energy, as more particularly described in step 919 of FIG. 9. Such on-site generated electricity 1107 is in turn used, among other things, to power one or more refrigeration units 1108 that, as designated by arrow 1109, maintains cryogenic hydrogen storage tank(s) 1005(b) at the desired temperature level to retain the quantity of hydrogen needed by LH2 off-takers, and temporary storage before the controlled release of LH2 into vaporization unit(s) 1105.

As the hydrogen expands within vaporization units 1105, the foregoing disclosed system and method enables GH2 to be stored at the desired pressure in one or more GH2 storage tank(s) 1003(b) designed for such pressure(s). This system and method comprising the cascade of tanks, controlled release valves, and thermal management controls to regulate such expansion, thereby minimizes (and in a preferred embodiment, entirely avoids) the need for mechanical compression of such GH2 to the desired pressure for distribution to the one or more end-users with tanker trucks 1110 and dedicated hydrogen pipes 1111, preferably within existing pipelines and pipeline rights-of-way 1112, as disclosed in Applicant's '864 patent.

In 2019, Oak Ridge National Laboratory published a technical and economic feasibility study (the “ORNL Study”) that compares the use of thermal compression to create hydrogen pressures in excess of 10,000 psi (˜700 bar) with the conventional approach of using mechanical components such as compressors or cryogenic liquid pumps to build-up pressure for hydrogen vehicle fueling stations. The thermal compression technology evaluated in the ORNL Study (CRADA Final Report NFE-16-06256) failed to reduce the delivered cost of hydrogen compared with traditional hydrogen vehicle fueling station compression technology due in large part to the amount of hydrogen boil-off losses incurred. Nevertheless, the ORNL Study provides a useful baseline description of thermal compression and the equipment used therein, and it is incorporated herein by this reference.

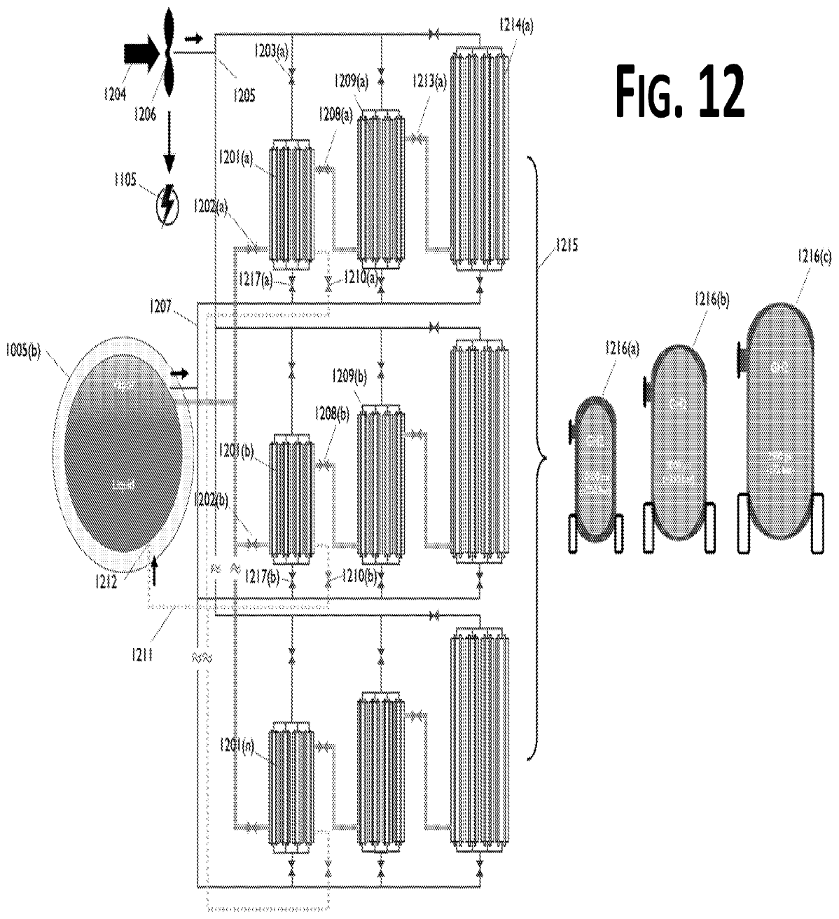

Turning next to FIG. 12, a flow diagram is presented that illustrates the optional use of thermal compression at depots and other hydrogen import locations to build the pressure desired for GH2 storage, transport, and distribution therefrom as LH2 held in cryogenic hydrogen storage tank(s) 1005(b) is simultaneously warmed to the optimal temperature for such GH2 storage, transport, and distribution. As shown therein, in this optional embodiment, vaporization/heat exchange unit 1109, as shown in FIG. 11, is comprised of a cascade of vaporization/heat exchange unit(s) 1201(a), (b) and (n), each capable of withstanding repeated cycles of varying pressure and temperature ranges; and gaseous hydrogen storage tank(s) 1003(b), as shown in FIG. 11, is comprised of GH2 tanks 1216(a)-(c), each designed for the appropriate pressure and temperature range.

When valve 1202(a) is opened, LH2 or near cryogenic hydrogen vapor flows from liquified hydrogen storage tank(s) 1005(b) into vaporization/heat exchange unit 1201(a). Once this unit has received the desired quantity of LH2 or near cryogenic hydrogen vapor, valve 1202(a) is closed and by opening valve 1203(a) heat provided directly or using a working fluid from the surrounding ambient air and other waste heat sources, as indicated by arrow 1204 flowing through “warm” line 1205 warms vaporization/heat exchange unit 1201(a). As described with respect to step 919 of FIG. 9, in an optional preferred embodiment, fan 1206 produces supplemental electricity 1105 from the “natural draft” created. In conjunction with the previously disclosed thermal management control system, “cold” line 1207 and the respective valves on such “hot” and “cold” lines control the rate that such LH2 is allowed to go through a state change from liquid to gaseous form and the near cryogenic hydrogen vapor is warmed.

With inlet valve 1202(a) and outlet valves 1208(a) and 1210(a) all closed, the natural expansion of such gaseous hydrogen as its temperature increases will build-up pressure within vaporization/heat exchange unit 1201(a) until valve 1208(a) is opened, thereby allowing such GH2 to flow into vaporization/heat exchange unit 1209(a), which is pre-cooled to be slightly below the temperature of the GH2 released from vaporization/heat exchange unit 1201(a) and which may be larger in size. Valve 1208(a) is then closed and valve 1210(a) is opened to allow any remaining hydrogen within vaporization/heat exchange unit 1201(a) to pass through line 1211 and return access port 1212 below the liquid level within liquified hydrogen storage tank(s) 1005(b) where, as this gas bubbles up through the LH2, it will be reabsorbed without a substantial change in the pressure or temperature of liquified hydrogen storage tank(s) 1005(a), as more particularly described in the ORNL Study.

Valve 1210(a) is then closed and vaporization/heat exchange unit 1209(a) further warms the GH2 with heat provided directly or using working fluid from the surrounding ambient air and waste heat sources 1204, and allows such gaseous hydrogen to build-up pressure until valve 1213(a) is opened, thereby permitting such GH2 to flow into one or more vaporization/heat exchange unit(s) 1214(a) and/or to fill using a combination of valves and pipes that are collectively represented by bracket 1215 into selective one(s) of GH2 tanks 1216(a)-(c) at the pressure level(s) corresponding to the desired GH2 off-take requirements for gaseous hydrogen storage, transport, and/or distribution. While such GH2 tanks 1216(a)-(c) are respectively labeled as being at 10,000 psi (˜700 bar); 5000 psi (˜350 bar); and 2500 psi (˜172 bar), the latter corresponding to the ASME-rated pressure of hydrogen pipe 308 disclosed in FIG. 3(c) of Applicant's prior '864 patent, the relative size and pressures shown are intended to be illustrative rather than limiting.

Once such GH2 has flowed out of vaporization/heat exchange unit 1201(a) and valves 1208(a) and 1210(a) have been closed, vaporization/heat exchange unit 1201(a) will be pre-cooled using LH2 and/or GH2 boil-off from cryogenic hydrogen storage tank(s) 1005(b) flowing through “cold” line 1207 once valve 1217(a) is opened. This pre-cooling step will avoid back-pressure or “flash vaporization” that would otherwise impede the flow of LH2 from cryogenic storage tank(s) 1005(a) into such unit. While vaporization/heat exchange unit 1201(a) is being pre-cooled to accept this next release of LH2 or near cryogenic GH2 from liquified hydrogen storage tank(s) 1005(a), valve 1202(b) is opened to permit LH2 to flow from liquified hydrogen storage tank(s) 1005(b) into vaporization unit 1201(b), where it undergoes a similar process until valve 1208(b) is opened, thereby permitting such GH2 to flow into the next vaporization/heat exchange unit 1209(b) and/or to fill through valves and piping 1215 selective one of GH2 tanks 1216(a)-(c) at the pressure level corresponding to forecasted off-take requirements.

Once such GH2 has flowed out of vaporization unit 1201(b), valve 1208(b) is closed, valve 1210(b) is opened to allow any residual hydrogen to be returned through line 1211 and return access port 1212. Thereafter, vaporization/heat exchange unit 1201(b) will be pre-cooled using LH2 and/or GH2 boil-off provided through “cold” line 1207 from cryogenic hydrogen storage tank(s) 1005(b) by opening valve 1217(b) before introducing the next release of LH2. The foregoing process will repeat through the balance of the cascade shown for vaporization/heat exchange units 1201(b) through 1201(n). Although not illustrated in FIG. 12, in an alternative embodiment some portion or all of such vaporization/heat exchange units, the foregoing described temperature and pressure regulation may occur within a similar cascade of GH2 storage tank(s) that are equipped with heating and cooling lines and valves or equivalent elements serving as “buffer tanks” in addition to storage once the desired pressure and temperature level is attained.

Persons of ordinary skill in the art will understand that depending on the total desired flow capacity and the time duration required to pre-cool such vaporization units 1201(a)-(n) for the next successive release of LH2 or GH, as applicable, additional vaporization units may be added; and the foregoing process will be repeated until all of GH2 storage tank(s) 1216(a)-(c) have been filled at the desired pressure and temperature level for their respective off-take method. Moreover, based on the foregoing description of the hydrogen thermal management system for airship 2006, it will be readily understood how ambient air or working fluid 1204 circulated through “warm” line 1205, and LH2 or chilled GH2 circulated through “cold” line 1211 in or around such vaporization unit(s) and GH2 storage tank(s) may be used to maintain the contents thereof at the desired temperature and pressure levels.

It will be apparent from FIG. 12 and the corresponding narrative how the disclosed system, method and apparatus will overcome the problems identified by the ORNL Study with respect to needing to vent substantial quantities of off-gas. In contrast thereto, within the cascade illustrated in FIG. 12, rather than venting hydrogen, any excess gas is either returned through line 1211 and return access port 1212 or vented into the next vaporization/heat exchange unit within the cascade until all but the desired retention quantity of the LH2 has been vaporized and stored at the desired pressure level to be thereafter loaded onto trucks 1110 or released into hydrogen pipes 1111, each at the desired pressure level. Similarly, depending on its temperature and pressure after selectively flowing through vaporization/heat exchange units 1201(a), 1209(a) and the one or more units comprising 1214(a), and the corresponding vaporization/heat exchange units elsewhere in the cascade, the GH2 flowing through “cold” line 1207 may be recycled to liquified hydrogen storage tank(s) 1005(b) through line 1211 and return access port 1212, be used to generate onsite power through one or more fuel cell units (not shown), or alternatively may fill selective one(s) of GH2 tanks 1216(a)-(c) through the combination of valves and pipes that are collectively represented by bracket 1215. Such system, method and apparatus thereby avoid wasting any of the LH2 or GH2 through venting, and are able to utilize much of the energy “invested” to liquefy the hydrogen as work to build pressure that would otherwise be lost as heat.

Persons of ordinary means in the art will readily appreciate that, in an alternative embodiment, such GH2 may also be mixed with natural gas and transported via existing natural gas lines or converted to other products such as ammonia, although these optional uses are likely to result in a less valuable product than pure hydrogen. Persons of ordinary means in the art will also readily appreciate that the foregoing system, method and disclosed apparatus will avoid the need for venting hydrogen to the atmosphere and will minimize the cost of the hydrogen by making it possible to transfer the investment in liquification from where energy costs per kWh are very low, to where the compression and consumption of such hydrogen occurs and where energy costs per kWh are significantly higher.

From the foregoing disclosure, it will be appreciated that, although specific implementations have been described herein for purposes of illustration, various modifications may be made without deviating from the spirit and scope of the appended claims and the elements recited therein. In addition, while certain aspects have been presented as optional or preferred embodiments, all such embodiments are not required and thus may be incorporated as dictated by the circumstances to achieve the desired result. Moreover, while certain aspects are presented below in certain claim forms, the inventors contemplate the various aspects in any available claim form. Various modifications and changes may be made as would be obvious to a person skilled in the art having the benefit of the foregoing disclosure. These disclosures are intended to encompass and embrace all such modifications and changes, and accordingly, the above description should be regarded in an illustrative rather than restrictive sense.

1. A hydrogen storage and thermal management system comprising:
at least one liquid hydrogen storage tank;
at least one gaseous hydrogen storage tank;
a piping pathway in fluid communication with the at least one liquid hydrogen storage tank and the at least one gaseous hydrogen storage tank;
at least one heat exchanger incorporated within at least one piping pathway; and
at least one fuel cell in fluid communication with the at least one heat exchanger.

2. The hydrogen storage and thermal management system of claim 1, further comprising at least one manifold in fluid communication with at least one liquid hydrogen storage tank wherein such at least one manifold is configured to allow the at least one liquid hydrogen tank to be filled or drained.

3. The hydrogen storage and thermal management system of claim 1, further comprising at least one manifold in fluid communication with at least one liquid or gaseous hydrogen storage tank wherein such at least one manifold is configured to allow gaseous hydrogen to be selectively directed throughout the piping pathways or hydrogen storage tanks.

4. The hydrogen storage and thermal management system of claim 1, wherein the piping pathways contains one or more turbopumps or compressors.

5. The hydrogen storage and thermal management system of claim 1, further comprising one or more valves configured to control the flow rate of gaseous and/or liquid hydrogen throughout the piping pathways.

6. The hydrogen storage and thermal management system of claim 3, wherein the at least one manifold can also be used for off-gassing regulation and pressure management of the at least one liquid or gaseous hydrogen storage tank.

7. The hydrogen storage and thermal management system of claim 1, wherein at least one pipe in the piping pathways is a drainage pipe.

8. The hydrogen storage and thermal management system of claim 1, wherein each of the at least one liquid hydrogen storage tanks is configured with an emergency over-pressure burst disk configured to rupture to vent gaseous hydrogen via at least one vent pipe.

9. The hydrogen storage and thermal management system of claim 2, further comprising one or more insulated drains for the release of hydrogen outside of a transport vehicle.

10. The hydrogen storage and thermal management system of claim 9, wherein such transport vehicle is an airship, airplane, truck or ship.

11. The hydrogen storage and thermal management system of claim 9, wherein each of the at least one liquid hydrogen storage containers are equipped with a drainage valve.

12. The hydrogen storage and thermal management system of claim 11, wherein the drainage valve allows for selective control of the liquid hydrogen flow.

13. The hydrogen storage and thermal management system of claim 1, wherein the at least one liquid hydrogen storage tank is composed of a single wall coated with one or more layers of insulation.

14. The hydrogen storage and thermal management system of claim 3, further comprising at least one sensor to gather information about at least one of the following variables: pressure, temperature, liquid fill level, fluid flow rate, and other general operating conditions.

15. The hydrogen storage and thermal management system of claim 14, further comprised of a control system configured to accept input data from the at least one sensor and to command the position of the one or more valves.

16. A method of utilizing gaseous hydrogen as a fuel source comprising:
sourcing boil-off gas from at least one liquid hydrogen storage tank;
transferring the boil-off gas into at least one heat exchanger via a piping pathway; and
transferring the boil-off gas from the at least one heat exchanger to at least one gaseous hydrogen storage tank via a piping pathway.

17. The method of claim 16, wherein the gaseous hydrogen is pressurized by one or more turbopump or compressor before entering the at least one heat exchanger.

18. The method of claim 16, wherein:
waste heat from at least one fuel cell is carried by a working fluid into the at least one heat exchanger and is used to heat liquid hydrogen into gaseous hydrogen or to raise the temperature of gaseous hydrogen;
gaseous hydrogen is carried by the piping pathway to the at least one gaseous hydrogen storage tank; and
cooled working fluid then returns to the at least one fuel cell and cools the at least one fuel cell.

19. The method of claim 16, wherein the piping pathway connects the at least one liquid hydrogen storage tank to the at least one gaseous hydrogen storage tank through at least one header tank.

20. The method of claim 16, wherein the at least one liquid hydrogen storage tank is at least partially emptied and filled by gaseous hydrogen from the at least one heat exchanger via the piping pathway.

21. The method of claim 19, wherein the hydrogen is pressurized using the one or more turbopump or compressor.

22. The method of claim 16, wherein the gaseous hydrogen is used in at least one fuel cell to produce electricity.

23. The method of claim 22, wherein the electricity powers the engine of a transport vehicle.

24. The method of claim 23, wherein such transport vehicle is an airship, airplane, truck or ship.

25. The method of claim 24, wherein the airship, truck or ship is used to transport liquid hydrogen from a location where such hydrogen is produced.

26. The method of claim 25, where the airship, airplane, truck or ship is used to transport freight or passengers.

27. A method of utilizing liquid hydrogen as a fuel source comprising:
transferring liquid hydrogen from at least one liquid hydrogen storage tank to a header tank;
adding heat to a header tank to increase the boil-off rate of liquid hydrogen;
transferring gaseous hydrogen via the piping pathway to one or more turbopump or compressor;
pressurizing the gaseous hydrogen with the one or more turbopump or compressor;
transferring the pressurized gaseous hydrogen via the piping pathway to at least one heat exchanger;
heating the pressurized gaseous hydrogen to a selected temperature; and
transferring the gaseous hydrogen to at least one gaseous hydrogen storage tank.

28. The method of claim 27, wherein gaseous hydrogen from at least one gaseous hydrogen storage tank is used in at least one fuel cell to produce electricity.

29. The method of claim 28, wherein the electricity powers the engine of a transport vehicle.

30. The method of claim 29, wherein such transport vehicle is an airship, airplane, truck or ship.

31. The method of claim 28, wherein waste heat from the at least one fuel cell is carried by a working fluid into the at least one header tank or at least one heat exchanger.

32. The method of claim 28, wherein cooled working fluid is returned to the at least one fuel cell and cools the at least one fuel cell.

33. The method of claim 27, wherein the liquid hydrogen leaves the at least one liquid hydrogen storage tank and the at least one heat exchanger at a temperature and pressure sufficient to eliminate the need for the use of the one or more turbopump or compressor.

34. A method of maintaining neutral buoyancy of an airship while delivering liquid hydrogen to a depot comprising the steps of:
loading liquid hydrogen into a cargo bay of the airship;
transporting the liquid hydrogen to an intended destination;
positioning the airship for delivery at the destination;
unloading a selected weight of liquid hydrogen;
uploading a corresponding weight of water or cargo to offset the unloaded selected weight of liquid hydrogen; and
directing the offloaded liquid hydrogen to at least one liquid hydrogen storage tank, at least one vaporizer heat exchange unit, at least one delivery vehicle, or at least one liquid hydrogen pipeline.

35. The method of claim 34, further comprising the steps of:
utilizing at least one vaporizer heat exchange unit to transform liquid hydrogen to gaseous hydrogen;
storing said gaseous hydrogen in at least one gaseous hydrogen storage tank; and
releasing gaseous hydrogen from such at least one gaseous hydrogen storage tank to at least one other gaseous hydrogen storage tank, at least one vaporizer heat exchange unit, at least one delivery vehicle, or at least one gaseous hydrogen pipeline.

36. The method of claim 34, further comprising the step of producing electricity from the depot through at least one of the following means: the flow of liquid hydrogen into said at least one vaporizer heat exchange unit, the Seebeck Effect, pressure change, or temperature change of the hydrogen.

37. A method of using thermal compression at a depot or other hydrogen storage location to provide the pressure desired for gaseous hydrogen storage, transport, and/or distribution comprising the steps of:
providing at least one liquified hydrogen storage tank;
having a first vaporization heat exchange unit in fluid communication with said at least one liquid hydrogen storage tank;
filling said first vaporization heat exchange unit via an inlet valve to said first vaporization heat exchange unit with a selected amount of liquid hydrogen;
heating said first vaporization heat exchange unit directly or using a working fluid from the surrounding ambient air or other waste heat sources, wherein said liquid hydrogen expands into a gaseous state;
providing at least one release outlet valve in fluid communication with said first vaporization heat exchange unit and in further fluid communication with an inlet valve in fluid communication with a second vaporization heat exchange unit, wherein said at least one release valve opens at a selected pressure of the hydrogen in the first vaporization heat exchange unit.

38. The method of claim 37, further comprising the step of avoiding back-pressure or flash vaporization impeding the flow of liquid hydrogen from the at least one liquid hydrogen storage tank into said first vaporization heat exchange unit by pre-cooling said first vaporization heat exchange unit before opening the inlet valve to said first vaporization heat exchange unit.

39. The method of claim 37, further comprising the step of avoiding back-pressure or flash vaporization impeding the flow of gaseous hydrogen into said second vaporization heat exchange unit by pre-cooling said second vaporization heat exchange unit to be below the temperature of the gaseous hydrogen in said first vaporization heat exchange unit before the release valve in said first vaporization heat exchange unit opens.

40. The method of claim 39, further comprising the steps of:
providing a further release valve in fluid communication with said second vaporization heat exchange unit and in further fluid communication with an inlet valve in fluid communication with a third vaporization heat exchange unit;
pre-cooling the temperature of said third vaporization heat exchange unit to be below the temperature of the gaseous hydrogen in said second vaporization heat exchange unit;
allowing the pressure of such gaseous hydrogen to build-up to a selected pressure within said second vaporization heat exchange unit, wherein said selected pressure opens said further release valve thereby permitting such gaseous hydrogen to flow into said third vaporization heat exchange unit;
using a working fluid to warm the gaseous hydrogen within said third vaporization heat exchange unit to expand said gaseous hydrogen within said third vaporization heat exchange unit to a selected pressure level corresponding to the desired gaseous off-take requirements for gaseous hydrogen storage, transport and/or distribution.

41. The method according to claim 40, wherein:
at least one of said vaporization heat exchange units is pre-cooled using liquid hydrogen or gaseous hydrogen boil-off from said liquid hydrogen storage tank; and/or
said working fluid is provided by a natural draft of ambient air.

42. The method of claim 41, further comprising the step of utilizing the flow of hydrogen into at least one of said vaporization heat exchange units to produce electricity through at least one of the following: the flow of liquid hydrogen into said first vaporization heat exchange unit, mechanical energy produced by the flow of gaseous hydrogen through the outlet valve of at least one vaporization heat exchange unit or by the natural draft of ambient air, the Seebeck Effect, pressure change, or temperature change of the hydrogen.
